(19) United States
(12) Patent Application Publication
(10) Pub. No.: US 2026/0101833 A1
(43) Pub. Date: Apr. 16, 2026

(54) STEERING SYSTEM FOR AN ARTICULATING VEHICLE

(71) Applicant: Venture Products, Inc., Orrville, OH (US)

(72) Inventors: Stuart RIGGENBACH, Wooster, OH (US); Jeffrey C. LIGGETT, North Lawrence, OH (US)

(73) Assignee: Venture Products, Inc., Orrville, OH (US)

(21) Appl. No.: 19/267,858

(22) Filed: Jul. 14, 2025

Related U.S. Application Data
(60) Provisional application No. 63/705,870, filed on Oct. 10, 2024.

(51) Int. Cl. A01B 69/00; A01B 69/08; G05D 1/223; G05D 1/227; G05D 1/229; G05D 1/243; G05D 1/648; G05D 105/15; G05D 107/20

(52) U.S. Cl. CPC A01B 69/007; A01B 69/006; G05D 1/223; G05D 1/227; G05D 1/229; G05D 1/243; G05D 1/648; G05D 2105/15; G05D 2107/23

(57) ABSTRACT

A steering assist system operably engaged with an articulating tractor at a pivot point. The steering assist system includes a controller, a sensor unit operably engaged at the pivot point of an articulating chassis of the articulating tractor, a steering actuator operably engaged with a front articulating frame of the articulating chassis and a rear articulating frame of the articulating chassis to pivot the articulating chassis at the pivot point based on at least one output from the controller, and a steering unit operable with the controller to input one or more steering commands to steer the articulating tractor. The sensor unit of the steering assist system is configured to measure rotation of the articulating chassis about a vertical axis of the articulating tractor at the pivot point.

### REFERENCE TO RELATED APPLICATIONS

This application claims the benefit of U.S. Provisional Application Ser. No. 63/705,870, filed on Oct. 10, 2024; the disclosure of which is incorporated herein by reference.

### TECHNICAL FIELD

This disclosure is directed to a steering system using a sensor unit that measures displacement of an articulating frame of an articulating tractor to assist in steering capabilities.

### BACKGROUND ART

Ball joints and similar axial components are critical components used in suspension and steering systems of various types of vehicles. In general, ball joints are commonly used to enable independent movement between two or more steering or suspension elements in two separate planes. With the inclusion of ball joints in suspension and steering systems, contact with the ground surface by the ground engaging wheels and tires of the vehicles may be maximized while providing more effective vehicle control and tire wear.

However, ball joints and similar axial components discussed previously are simply mechanical components that do not offer further functionality outside of their mechanical characteristics. As such, vehicles that utilize ball joints and similar axial components must be equipped with other elements and sensors to monitor or measure suspension and steering systems. In some circumstances, knowing the position and/or orientation of the steering system is critical in remotely controlled vehicles and/or autonomous vehicles in order for such vehicles to be driven efficiently and to reduce error or mistakes. Even if sensors are used to monitor or measure suspension and steering systems, such sensors must be housed away from the ball joints and axial components due to the environment said ball joints and axial components experience during normal operations.

### SUMMARY OF THE INVENTION

In one aspect, an exemplary embodiment of the present disclosure may provide a ball joint sensor operably engaged with an articulating tractor at a pivot point. The ball joint sensor includes a housing operably engaged with a first articulating frame of the articulating tractor at the pivot point. The ball joint sensor also includes a ball joint member operably engaged with the housing and a second articulating frame of the articulating tractor at the pivot point. The ball joint sensor also includes a position indicator operably engaged with the ball joint member inside of the housing. The ball joint sensor also includes a position sensor operably engaged with the housing and spaced apart from the position indicator; wherein the position sensor is configured to measure and output displacement of the position indicator.

This exemplary embodiment or another exemplary embodiment may further include a turning output sent from the position sensor when the position indicator rotates about a vertical axis of the articulating tractor at the pivot point. This exemplary embodiment or another exemplary embodiment may further include an articulation output sent from the position sensor when the position indicator rotates about a longitudinal axis of the articulating tractor at the pivot point. This exemplary embodiment or another exemplary embodiment may further include that the housing further comprises: a first end that operably engages with the position sensor and defining a first opening; a second end opposite to the first end and defining a second opening; and a passageway defined between the first end and the second end and is configured to house the position indicator, a portion of the ball joint member, and a portion of the position sensor. This exemplary embodiment or another exemplary embodiment may further include that the housing further comprises: a flange operably engaged with the first articulating frame of the articulation tractor. This exemplary embodiment or another exemplary embodiment may further include a shroud operably engaged with the housing at the second end and a shank of the ball joint member; wherein the shroud covers the second opening of the housing. This exemplary embodiment or another exemplary embodiment may further include that the housing further comprises: a groove defined in the housing at the second end; wherein a first end of the shroud seats inside of the groove and a second end of the shroud engages with the ball joint member. This exemplary embodiment or another exemplary embodiment may further include a retaining ring operably engaging the shroud with the housing inside of the groove. This exemplary embodiment or another exemplary embodiment may further include a race member positioned inside of and engaged with the housing and is configured to receive a ball stud of the ball joint member. This exemplary embodiment or another exemplary embodiment may further include a spacer operably engaged with the race member and the position sensor such that the spacer is positioned between the race member and the position sensor. This exemplary embodiment or another exemplary embodiment may further include an aperture defined in the housing and is in fluid communication with a passageway of the housing; and a circumferential channel defined in the race member and is aligned with the aperture; wherein lubricant is injected through the aperture to be disposed inside of the race member and the spacer. This exemplary embodiment or another exemplary embodiment may further include a wave spring operably engaged with the spacer and the position sensor; wherein the wave spring is configured to apply a biasing force on the spacer and the position sensor. This exemplary embodiment or another exemplary embodiment may further include a set screw operably engaging with the housing and the position sensor for maintaining the position sensor inside of housing. This exemplary embodiment or another exemplary embodiment may further include that the position sensor is configured to transmit at least one of a turning output and an articulation output to a remote control unit via a controller on-board the tractor.

In another aspect, an exemplary embodiment of the present disclosure may provide a method of measuring a rotational position of an articulating tractor at a pivot point. The method comprises steps of: engaging a housing of a ball joint sensor with a first articulating frame of the articulating tractor at the pivot point; engaging a ball joint member of the ball joint sensor with the housing and a second articulating frame of the articulating tractor at the pivot point; engaging a position indicator of the ball joint sensor with the ball joint member inside of the housing; engaging a position sensor of the ball joint sensor with the housing and spaced apart from the position indicator; and measuring displacement of the position indicator, via the position sensor, relative to an axis of the position sensor when the first articulating frame rotates relative to the second articulating frame.

This exemplary embodiment or another exemplary embodiment may further include a step of transmitting a turning output from the position sensor to a controller on-board the articulating tractor when the position indicator rotates about a vertical axis of the articulating tractor at the pivot point. This exemplary embodiment or another exemplary embodiment may further include a step of transmitting an articulation output from the position sensor to a controller on-board the articulating tractor when the position indicator rotates about a longitudinal axis of the articulating tractor at the pivot point. This exemplary embodiment or another exemplary embodiment may further include a step of transmitting at least one of a turning output and an articulation output to a remote control unit via a controller on-board the tractor. This exemplary embodiment or another exemplary embodiment may further include steps of engaging a shroud to the housing and to a shank of the ball joint member; and protecting the position indicator and the position sensor, by the shroud, at a position that is below the housing and the shank.

In another aspect, an exemplary embodiment of the present disclosure may provide a ball joint sensor operably engaged with a steering system of a vehicle. The ball joint sensor includes a housing operably engaged with a first steering component of the steering system of the vehicle. The ball joint sensor also includes a ball joint member operably engaged with the housing and a second steering component of the steering system of the vehicle of the vehicle. The ball joint sensor also includes a position indicator operably engaged with the ball joint member inside of the housing. The ball joint sensor also includes a position sensor operably engaged with the housing and spaced apart from the position indicator; wherein the position sensor is configured to measure and output displacement of the position indicator.

In another aspect, an exemplary embodiment of the present disclosure may provide a sensor unit operably engaged with a steering system of a vehicle. The sensor unit includes a housing operably engaged with a first steering component of the steering system of the vehicle. The sensor unit also includes a mechanical joint member operably engaged with the housing and a second steering component of the steering system of the vehicle. The sensor unit also includes a position sensor assembly operably engaged with the mechanical joint member inside of the housing such that the position sensor assembly is fully sealed inside of the housing; wherein the position sensor assembly is configured to measure and output displacement of the mechanical joint member inside of the housing.

This exemplary embodiment or another exemplary embodiment may further include that the position sensor assembly further comprises: a position indicator operably engaged with the mechanical joint member inside of the housing; and a position sensor operably engaged with the housing and spaced apart from the position indicator. This exemplary embodiment or another exemplary embodiment may further include that the housing further comprises: a first end that operably engages with the position sensor and defining a first opening; a second end opposite to the first end and defining a second opening; and a passageway defined between the first end and the second end and is configured to house and seal the position indicator, a portion of the mechanical joint member, and the position sensor. This exemplary embodiment or another exemplary embodiment may further include that the mechanical joint member is a ball joint member.

In another aspect, an exemplary embodiment of the present disclosure may provide an articulating tractor. The articulating tractor includes an articulating chassis that is pivotable at a pivot point between a front end of the articulating chassis and a rear end of the articulating chassis. The articulating tractor also includes a set of ground engaging wheels operably engaged with the articulating chassis between the front end and the rear end. The articulating tractor also includes a sensor unit operably engaged with the articulating chassis at the pivot point. The articulating tractor also includes a position sensor assembly of the sensor unit operably engaged with a housing of the sensor unit such that the position sensor assembly is fully sealed inside of the housing.

This exemplary embodiment or another exemplary embodiment may further include a first end of the sensor unit operably engaged with a front articulating frame of the articulating chassis; and a second end of the sensor unit operably engaged with a rear articulating frame of the articulating chassis; wherein the position sensor assembly is configured to measure displacement at the pivot point between the front articulating frame and the rear articulating frame. This exemplary embodiment or another exemplary embodiment may further include that the position sensor assembly further comprises: a position indicator operably engaged with a mechanical joint member inside of the housing; and a position sensor operably engaged with the housing and spaced apart from the position indicator. This exemplary embodiment or another exemplary embodiment may further include a turning output sent from the position sensor when the position indicator rotates about a vertical axis of the articulating tractor at the pivot point. This exemplary embodiment or another exemplary embodiment may further include an articulation output sent from the position sensor when the position indicator rotates about a longitudinal axis of the articulating tractor at the pivot point. This exemplary embodiment or another exemplary embodiment may further include a shroud of the sensor unit operably engaged with the housing and the mechanical joint member; wherein the shroud is configured to protect the position indicator and the position sensor between the rear articulating frame and the housing. This exemplary embodiment or another exemplary embodiment may further include that the mechanical joint member is a ball joint. This exemplary embodiment or another exemplary embodiment may further include a controller operable with the position sensor assembly and supported by the articulating chassis; wherein the position sensor assembly outputs a displacement signal to the controller based on the displacement of the articulating chassis at the pivot point. This exemplary embodiment or another exemplary embodiment may further include that the controller is adapted to transmit at least one displacement signal to a remote control unit via a controller on-board the tractor.

In another aspect, an exemplary embodiment of the present disclosure may provide an articulating tractor. The articulating tractor includes an articulating chassis that is pivotable at a pivot point between a front end of the articulating chassis and a rear end of the articulating chassis. The articulating tractor also includes a set of ground engaging wheels operably engaged with the articulating chassis between the front end and the rear end. The articulating tractor also includes a ball joint sensor unit operably engaged with the articulating chassis at the pivot point, the ball joint sensor unit having a position sensor assembly operably engaged with a housing of the ball joint sensor unit such that the position sensor assembly is sealed inside of the housing.

This exemplary embodiment or another exemplary embodiment may further include a first end of the ball joint sensor unit operably engaged with a front articulating frame of the articulating chassis; and a second end of the ball joint sensor unit operably engaged with a rear articulating frame of the articulating chassis; wherein the position sensor assembly is configured to measure displacement at the pivot point between the front articulating frame and the rear articulating frame. This exemplary embodiment or another exemplary embodiment may further include that that position sensor assembly further comprises: a position indicator operably engaged with a ball joint member inside of the housing; and a position sensor operably engaged with the housing and spaced apart from the position indicator. This exemplary embodiment or another exemplary embodiment may further include a turning output sent from the position sensor when the position indicator rotates about a vertical axis of the articulating tractor at the pivot point. This exemplary embodiment or another exemplary embodiment may further include an articulation output sent from the position sensor when the position indicator rotates about a longitudinal axis of the articulating tractor at the pivot point. This exemplary embodiment or another exemplary embodiment may further include a shroud of the ball joint sensor unit operably engaged with the housing and the ball joint member; wherein the shroud is configured to protect the position indicator and the position sensor between the rear articulating frame and the housing. This exemplary embodiment or another exemplary embodiment may further include a controller operable with the position sensor assembly and supported by the articulating chassis; wherein the position sensor assembly outputs a displacement signal to the controller based on the displacement of the articulating chassis at the pivot point. This exemplary embodiment or another exemplary embodiment may further include that the controller is adapted to transmit at least one displacement signal to a remote control unit via a controller on-board the tractor. This exemplary embodiment or another exemplary embodiment may further include that the housing further comprises: a first end that operably engages with the position sensor and defining a first opening; a second end opposite to the first end and defining a second opening; and a passageway defined between the first end and the second end and is configured to house the position indicator, a portion of the ball joint member, and a portion of the position sensor. This exemplary embodiment or another exemplary embodiment may further include that the housing further comprises: a flange operably engaged with the front articulating frame of the articulation tractor. This exemplary embodiment or another exemplary embodiment may further include that the ball joint member comprises: a ball stud pivotably engaged with and sealed inside of the housing and configured to support the position indicator; and a shank extending outwardly from the ball stud and operably engaged with the rear articulating frame.

In yet another aspect, an exemplary embodiment of the present disclosure may provide a steering assist system operably engaged with an articulating tractor at a pivot point. The system includes: a controller; a sensor unit operably engaged at the pivot point of an articulating chassis of the articulating tractor; a steering actuator operably engaged with a front articulating frame of the articulating chassis and a rear articulating frame of the articulating chassis to pivot the articulating chassis at the pivot point based on at least one output from the controller; and a steering unit operable with the controller to input one or more steering commands to steer the articulating tractor; wherein the sensor unit is configured to measure rotation of the articulating chassis about a vertical axis of the articulating tractor at the pivot point.

This exemplary embodiment or another exemplary embodiment may further include a set of steering modes for the steering unit this stored on at least one computer readable medium encoded with instructions that is accessible by the controller. This exemplary embodiment or another exemplary embodiment may further include that the set of steering modes comprises: an on-board steering mode activated when the steering unit is being operated on-board the articulating tractor. This exemplary embodiment or another exemplary embodiment may further include that the set of steering modes comprises: a remote steering mode activated when the steering unit is being operated remotely from the articulating tractor. This exemplary embodiment or another exemplary embodiment may further include that the remote steering mode comprises: a setpoint value transmitted by the steering unit to steer the articulating tractor in at least one direction; and a feedback value measured by the sensor unit indicating a rotational position of the articulating chassis; wherein the controller is configured to adjust the steering actuator based on a comparison between the setpoint value transmitted by the steering unit and the feedback value measured by the sensor unit. This exemplary embodiment or another exemplary embodiment may further include that the remote steering mode further comprises: an adjusted steering signal transmitted to the steering actuator from the controller, wherein the adjusted steering signal matches the feedback value with the setpoint value. This exemplary embodiment or another exemplary embodiment may further include at least one computer readable medium that is accessible by the controller and encoded with instructions and a plurality of geographical waypoints to cut at least one mow line. This exemplary embodiment or another exemplary embodiment may further include that the at least one computer readable medium further comprises: a set of planned cutting path instructions to generate at least one planned cut path defined by at least two geographical waypoints of the plurality of geographical waypoints. This exemplary embodiment or another exemplary embodiment may further include that the set of planned path instructions comprises: a setpoint value transmitted by the steering unit to steer the articulating tractor in at least one direction; and a feedback value measured by the sensor unit indicating a rotational position of the articulating chassis. This exemplary embodiment or another exemplary embodiment may further include that when the steering unit is free from transmitting at least one steering command to the controller, at least one planned cut path is maintained by the controller; and wherein when the steering unit transmits the at least one steering command to the controller, the at least one planned cut path is terminated. This exemplary embodiment or another exemplary embodiment may further include a variable speed unit operable with the controller and the steering unit to adjust a speed of the articulating tractor when the steering unit is a remote control unit. This exemplary embodiment or another exemplary embodiment may further include that a holster mounted to the articulating tractor configured to hold the steering unit when the steering unit is a remote control unit.

In yet another aspect, an exemplary embodiment of the present disclosure may provide a method of measuring a rotational position of an articulating tractor at a pivot point. The method comprising steps of: receiving a steering input having a setpoint value from a steering unit of the articulating tractor; measuring the rotational position of an articulating chassis of the articulating tractor by a sensor unit of the articulating tractor; transmitting a feedback value to a controller, by the sensor unit, based on the rotational position of the articulating chassis; comparing the setpoint value and the feedback value with one another by the controller; and adjusting the rotational position of the articulating tractor, by a steering actuator of the articulating tractor, upon receiving an output signal to match the setpoint value with the feedback value.

This exemplary embodiment or another exemplary embodiment may further include a step of selecting from a set of steering modes for the steering unit this stored on at least one computer readable medium encoded with instructions that is accessible by the controller. This exemplary embodiment or another exemplary embodiment may further include that the step of selecting from the set of steering modes further comprises: selecting an on-board steering mode when the steering unit is being operated on-board the articulating tractor. This exemplary embodiment or another exemplary embodiment may further include that the step of selecting from the set of steering modes further comprises: selecting a remote steering mode when the steering unit is being operated remotely from the articulating tractor. This exemplary embodiment or another exemplary embodiment may further include a step of accessing at least one computer readable medium, by the controller, the at least one computer readable medium being encoded with instructions and a plurality of geographical waypoints to cut at least one mow line. This exemplary embodiment or another exemplary embodiment may further include that the step of accessing at least one computer readable medium further comprises: accessing a set of planned cutting path instructions stored on the at least one computer readable medium; and generating at least one planned cut path defined by at least two geographical waypoints of the plurality of geographical waypoints. This exemplary embodiment or another exemplary embodiment may further include that the step of accessing at least one computer readable medium further comprises: maintaining the at least one planned cut path, by the controller, when the steering unit is free from transmitting at least one steering command to the controller. This exemplary embodiment or another exemplary embodiment may further include that the step of accessing at least one computer readable medium further comprises: terminating the at least one planned cut path, by the controller, when the steering unit transmits at least one steering command to the controller.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a side elevation view of an articulating tractor equipped with ball joint sensor units, wherein the ball joint sensor units are each operably connected with a controller of the articulating tractor.

FIG. 2 is an enlarged side elevation view of one of the ball joint sensor units that is equipped to a front articulating frame of the articulating tractor and to a rear articulating frame of the articulating tractor.

FIG. 3 is an isometric perspective view of the ball joint sensor unit shown in FIG. 2.

FIG. 4 is a first side elevation view of the ball joint sensor unit shown in FIG. 2.

FIG. 5 is a sectional view of the ball joint sensor unit taken in the direction of line 5-5 shown in FIG. 4.

FIG. 6 is an enlarged region of the ball joint sensor unit that is highlighted in FIG. 5.

FIG. 7A in an operational view of the articulating tractor shown in a first position.

FIG. 7B in another operational view continuing from FIG. 7A, wherein the articulating tractor has turned from the first position to a second position about a pivot point of the articulating frame.

FIG. 7C is another operational view continuing from FIG. 7B, wherein a position sensor of the ball joint sensor unit is measuring displacement between the front articulating frame and the rear articulating frame relative to a vertical axis of the articulating tractor via a position indicator of the ball joint sensor unit.

FIG. 8 is another operational view of the articulating tractor, wherein the position sensor of the ball joint sensor unit is measuring displacement between the front articulating frame and the rear articulating frame relative to a longitudinal axis of the articulating tractor via the position indicator of the ball joint sensor unit.

FIG. 9 is a flowchart of an exemplary method of measuring a rotational position of an articulating tractor at a pivot point.

FIG. 10 is a flowchart of one exemplary steering mode or method executable by the controller of the articulating tractor.

FIG. 11A is an operational view of the controller executing the steering mode shown in FIG. 10, wherein inputs are applied to a remote control unit to output a turning command.

FIG. 11B in another operational view continuing from FIG. 11A, wherein the controller and the ball joint sensor unit are in communication upon receiving the turning command from remote control unit.

FIG. 11C in another operational view continuing from FIG. 11B, wherein the controller, an actuator controller, and a steering actuator are in communication to turn the articulating tractor upon receiving the turning command from remote control unit.

FIG. 12 is a flowchart of another exemplary steering mode or method executable by the controller of the articulating tractor.

FIG. 13A is an operational view of the controller executing the steering mode shown in FIG. 12 to generate a planned path for at least one mow line.

FIG. 13B in another operational view continuing from FIG. 13A, wherein the articulating tractor follows the planned path for the at least one mow line.

FIG. 13C in another operational view continuing from FIG. 13B, wherein the planned path is terminated based on at least one turning command output from the remote control unit.

Similar numbers refer to similar parts throughout the drawings.

### DETAILED DESCRIPTION

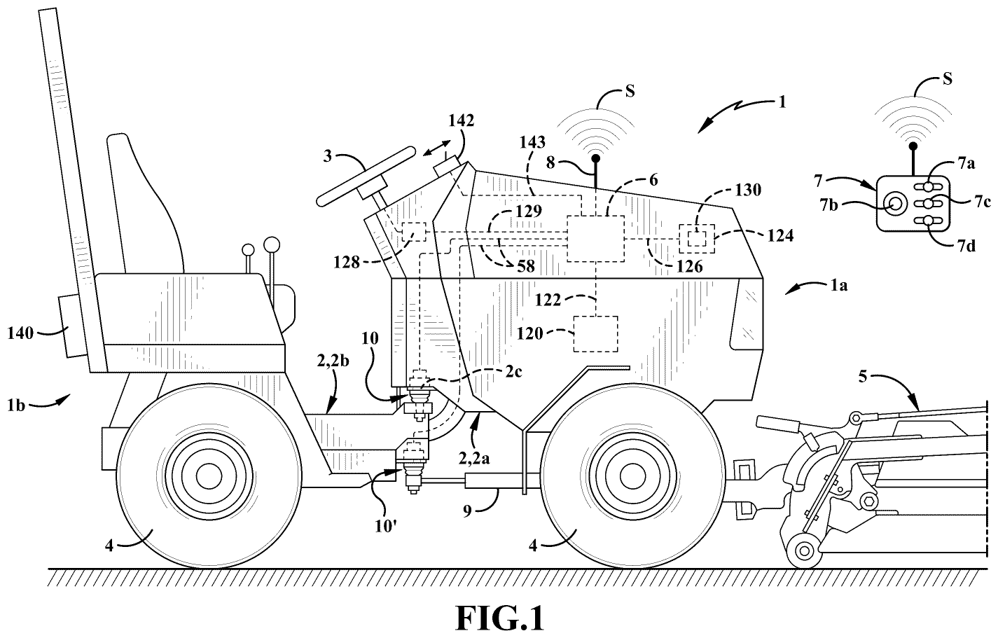

A drivable outdoor power equipment device in accordance with the present disclosure is illustrated in FIG. 1 and is shown generally at 1; the drivable outdoor power equipment device 1 may also be referred to as an articulating tractor or vehicle herein. Articulating tractor 1 has a front end 1a, a rear end 1b longitudinally opposite to the front end 1a, and a longitudinal direction defined therebetween. Articulating tractor 1 also includes a longitudinal axis that extends between the front end 1a and the rear end 1b and is parallel with the longitudinal direction of articulating tractor 1. During operation, articulating tractor 1 typically travels in a forward direction. When articulating tractor 1 moves in the forward direction, the front end 1a comprises the leading end of articulating tractor 1. In some instances, articulating tractor 1 may need to reverse, in which case the direction of travel will be opposite to the direction noted previously, and then rear end 1b will comprise the leading end of the articulating tractor 1.

It will be understood that any suitable vehicle, tractor, or drivable outdoor power equipment device may be used with an implement 5. One exemplary articulating tractor 1 for use with an implement discussed herein is a Ventrac compact tractor commercially available for sale and known in the industry as a Ventrac 4520 tractor. Another exemplary articulating tractor 1 for use with an implement discussed herein is a Ventrac compact tractor commercially available for sale and known in the industry as a Ventrac 4500 tractor.

Articulating tractor 1 includes an articulating chassis 2 that includes a first or front articulating frame 2a and a second or rear articulating frame 2b positioned behind the front articulating frame 2a. As best seen in FIG. 1, the front articulating frame 2a and the rear articulating frame 2b are connected at a pivot point 2c that allows for articulation between the front articulating frame 2a and the rear articulating frame 2b. As such, the articulating tractor 1 articulates at the pivot point 2c in order to turn, oscillate, and/or articulate the articulating tractor 1 in multiple directions. Particularly, the front articulating frame 2a and the rear articulating frame 2b pivot at the pivot point 2c in order to turn, oscillate, and/or articulate the articulating tractor 1 in multiple directions when traversing along uneven terrain. As discussed in greater detail below, the pivot point 2c is the central point of a ball stud of a ball joint member of a ball joint sensor unit that pivotably engages the front articulating frame 2a and the rear articulating frame 2b with one another. Articulating tractor 1 also includes a steering wheel 3 that controls the articulation of the articulating chassis 2 as the tractor 1 is controlled on-board by an operator.

It should be noted the front articulating frame 2a may support various types of components commonly used with articulating tractor 1, including an engine or motor, steering wheel, mechanical or hydraulic mechanisms, and other necessary components housed or maintained by this assembly, as well as new components that are discussed in greater detail below. It should also be noted the rear articulating frame 2b may support or maintain various types of components commonly used with articulating tractor 1, including an operating seat, controls of articulating tractor 1, and other necessary components housed or maintained by this assembly, as well as new components that are discussed in greater detail below.

Articulating tractor 1 also includes ground engaging wheels 4 that are mounted to articulating chassis 2 so that articulating tractor 1 may be driven across a ground surface. It should be noted that articulating tractor 1 may include more than one wheel at each corner of the articulating chassis 2 depending upon the operator's preferences when operating said articulating tractor 1. In one example, operator may install dual wheel assemblies to the articulating chassis 2 when the operator wants to prevents unnecessary damage to the ground surface or requires additional support when traversing uneven or sloped terrain.

Articulating tractor 1 may also include a controller 6 that is operable to communicate with an antenna or transmitting device 8. As best seen in FIG. 1, controller 6 is diagrammatically shown as a dashed box labeled 6 that is supported by the front articulating frame 2a. It should be noted that such illustration of controller 6 is for diagrammatic purposes and may be located or supported at any position that is capable to communicate with antenna 8 and with one or more ball joint sensors equipped to the articulating tractor 1, which is discussed in greater detail below. In operation, controller 6 may receive one or more outputs transmitted from a ball joint sensor discussed herein that includes data relating to the angle or pitch at which the front articulating frame 2a has displaced relative to the rear articulating frame 2b. In operation, controller 6 may also transmit one or more outputs received from a ball joint sensor to the antenna 8 so that such outputs may be viewed and seen from a remote control unit 7 that is separate from the articulating tractor 1; such outputs between the controller 6 and the remote control unit 7 are diagrammatically shown as lines labeled “S” in FIG. 1 near the antenna 8 and the remote control unit 7.

As mentioned briefly above, articulating tractor 1 may include one or more ball joint sensor units 10 (hereinafter “sensor unit 10”). Sensor unit 10 includes a first end 10a that is positioned proximate to the front articulating frame 2a, and a second end 10b that is positioned proximate to the rear articulating frame 2b and is opposite to the first end 10a. As discussed in greater detail below, sensor unit 10 is configured to measure the articulation and oscillation of the articulating chassis 2 when articulating tractor 1 traverse over terrain. Such measurement of articulation or oscillation of the articulating chassis 2 may be useful or helpful to operators that are operating the articulating tractor 1 from the tractor itself or at a position remote from the articulating tractor 1. Such components and elements of the sensor unit 10 are discussed in greater detail below.

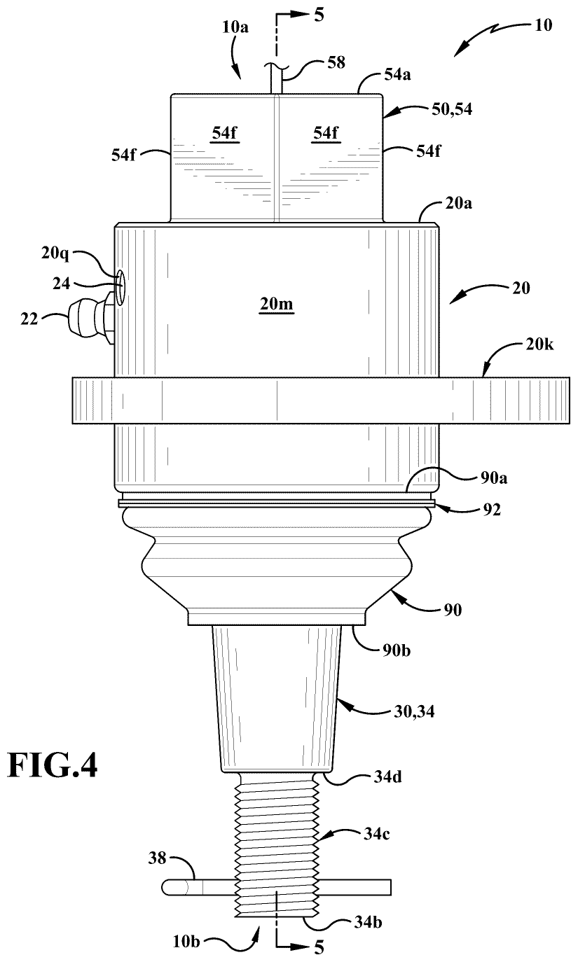

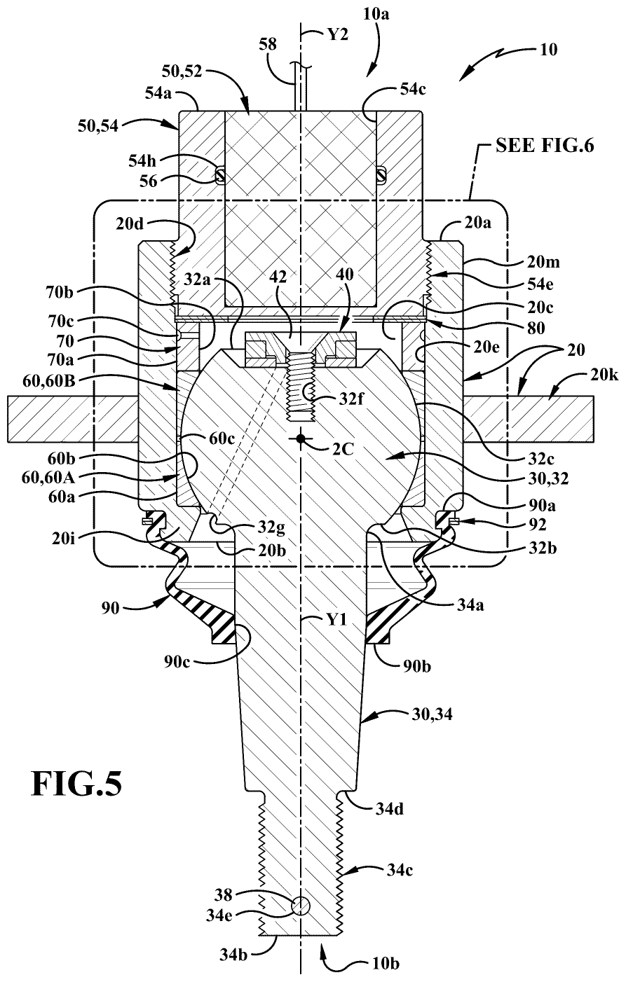

Sensor unit 10 includes a housing 20 that operably engages with the front articulating frame 2a. As best seen in FIGS. 4-5, housing 20 includes a top or first end 20a, a bottom or second end opposite to the first end 20a, and a lengthwise axis extending between the first end 20a and the second end 20b. It should be understood that the first end 20a and the second end 20b are each open ends. Housing 20 also defines a passageway 20c between the first end 20a and the second end 20b which is accessible at either the first end 20a or the second end 20b. As discussed in greater detail below, a portion of a ball joint member, a position indicator operably engaged with the ball joint member, and a position sensor are housed inside of the passageway 20c of the housing 20.

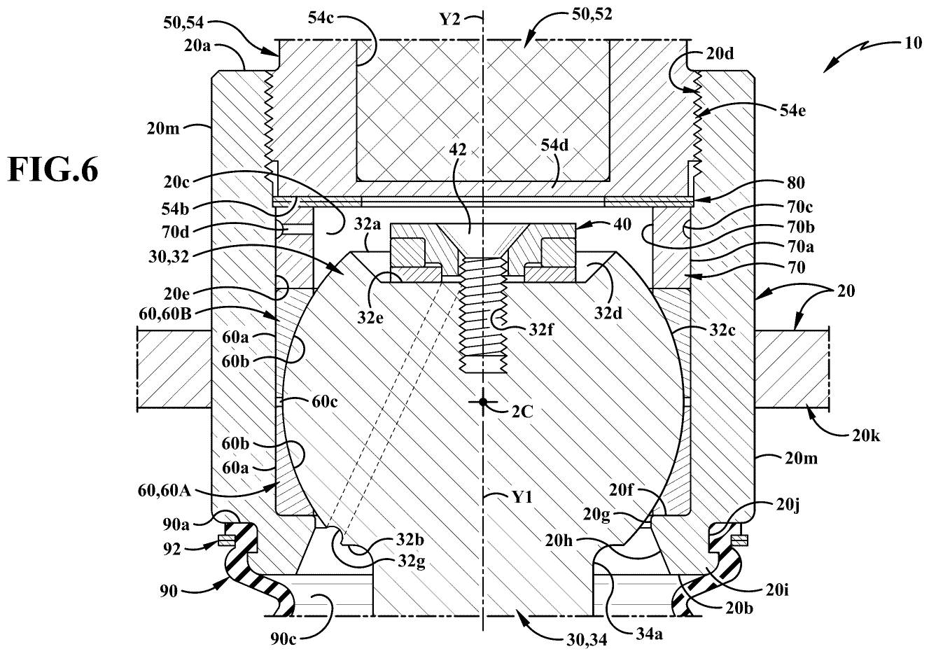

Still referring to housing 20, housing 20 also defines an internal threading 20d that extends downwardly from the first end 20a to a first vertical internal wall 20e inside of the passageway 20c (see FIG. 6). Still referring to FIG. 6, first vertical internal wall 20e extends downwardly from the internal threading 20d towards the second end 20b to a horizontal internal wall 20f. The horizontal internal wall 20f of housing 20 extends orthogonally relative to the lengthwise axis of housing 20 from the first vertical internal wall 20e to a second vertical internal wall 20g. The second vertical internal wall 20g of housing 20 extends parallel relative to the lengthwise axis of housing 20 from the horizontal internal wall 20f to an angled internal wall 20h. The angled internal wall 20h of housing 20 extends from the second vertical internal wall 20g to the second end 20b at an angle measured relative to the lengthwise axis of housing 20. As discussed in greater detail below, the angled internal wall 20h may enable a portion of a shank of a ball joint member of sensor unit 10 to articulate inside of the sensor unit 10 when the ball joint member articulates with the rear articulating frame 2b. It should be noted that internal threading 20d, first vertical internal wall 20e, horizontal internal wall 20f, second vertical internal wall 20g, and angled internal wall 20h collectively define an interior wall between the first end 20a and the second end 20b.

Still referring to housing 20, housing 20 also includes an extension 20i that is defined between the horizontal internal wall 20f and the second end 20b. As best seen in FIG. , extension 20i of housing 20 defines a groove 20j between the horizontal internal wall 20f and the second end 20b. In the present disclosure, the groove 20j is defined circumferentially about the extension 20i such that the groove 20j is continuous and uninterrupted along extension 20i. In other exemplary embodiments, groove 20j may be defined in segments along the extension 20i. Such use and purpose of extension 20i and groove 20j are discussed in greater detail below.

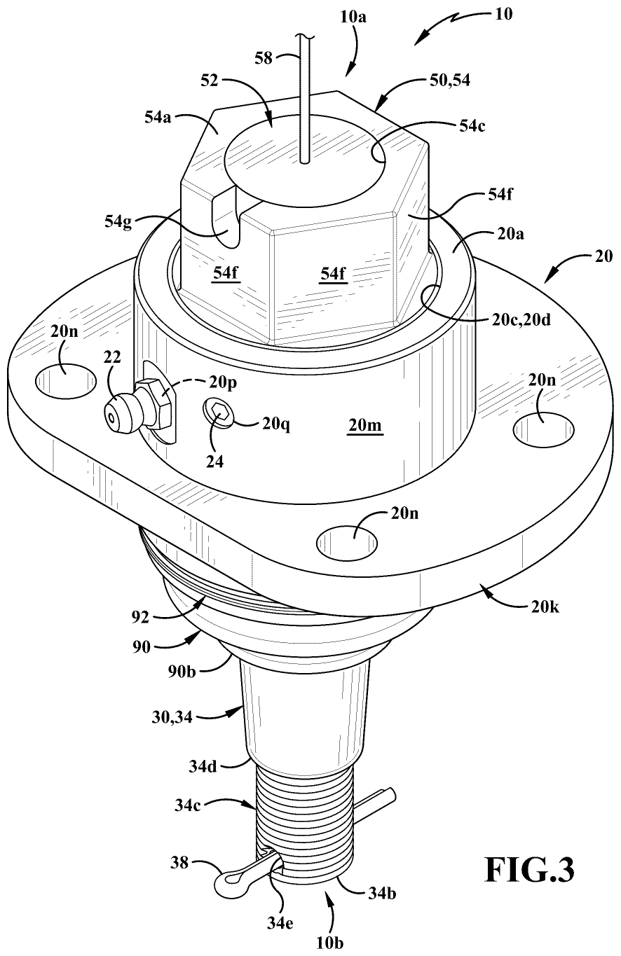

Still referring to housing 20, housing 20 also includes a flange 20k that extends outwardly from an exterior wall 20m of housing 20 that is spaced apart from the passageway 20c. As best seen in FIG. 3, flange 20k defines a plurality of attachment opening 20n where each attachment opening 20n extends entirely through the flange 20k. As discussed in greater detail below, flange 20k operably engages with the front articulating frame 2a via attachment mechanisms at the plurality of attachment openings 20n.

Still referring to housing 20, housing 20 also defines a side lubricant aperture 20p and a side securement aperture 20q (see FIG. 3). In the present disclosure, side lubricant aperture 20p extends entirely through the housing 20 between the internal threading 20d or the first vertical internal wall 20e and the exterior wall 20m. With such configuration, the passageway 20c is in fluid communication with the exterior environment surrounding the housing 20 at the side lubricant aperture 20p. The side lubricant aperture 20p is configured to receive a lubricant cap 22 such that the lubricant cap 22 may engage with the housing 20 to allow an operator to inject lubricant into the housing 20, which is discussed in greater detail below. Similarly, side securement aperture 20q extends entirely through the housing 20 between the internal threading 20d or the first vertical internal wall 20e and the exterior wall 20m. With such configuration, the passageway 20c is also in fluid communication with the exterior environment surrounding the housing 20 at the side securement aperture 20q. The side securement aperture is configured to receive a set screw 24 such that the set screw 24 may engage with the housing 20 to allow an operator to further maintain and secure a position sensor with the housing 20 inside of the passageway 20c, which is discussed in greater detail below.

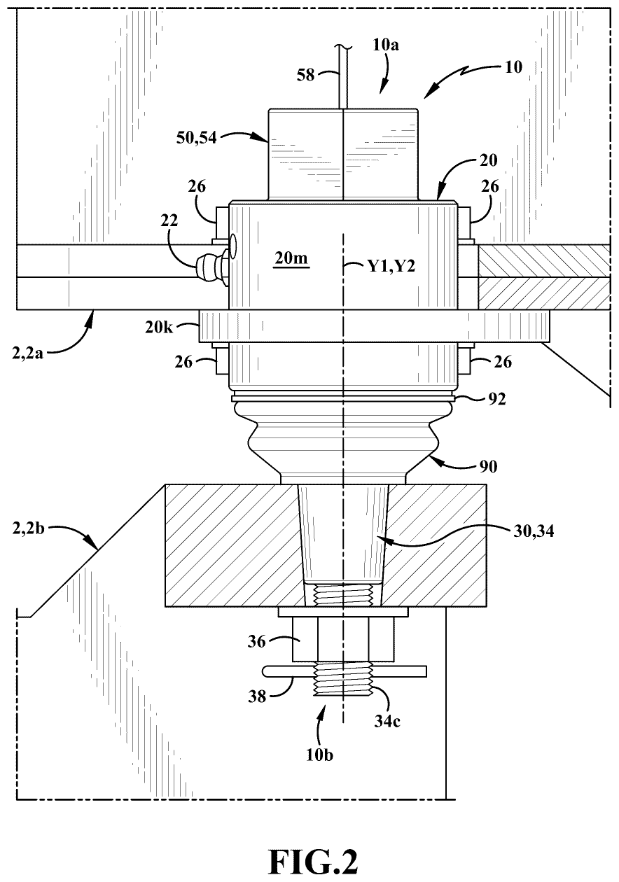

Still referring to housing 20, a set of attachment mechanisms 26 may be used to operably engage the housing 20 with the front articulating frame 2a. As best seen in FIG. 2, each attachment mechanism of the set of attachment mechanism 26 operably engages with the front articulating frame 2a at apertures (not illustrated) defined in the front articulating frame 2a and with the flange 20k of the housing 20 at the plurality of attachment openings 20n. It should be understood that such attachment mechanisms 26 may be a connector or fastener that threadedly engage with a nut or similar threaded component to maintain and secure the housing 20 with the front articulating frame 2a at the pivot point 2c.

Sensor unit 10 also includes a ball joint member 30 that operably engages with the rear articulating frame 2b and with the housing 20 at pivot point 2c. As described in more detail below, a portion of the ball joint member 30 is configured to pivot inside of the housing 20, particularly the passageway 20c, based on the terrain the articulating tractor 1 traverses during operation. The components and features of the ball joint member 30 are now discussed in greater detail below.

Ball joint member 30 includes a ball stud 32 that pivotably engages with the housing 20 inside of passageway 20c. As best seen in FIG. 6, ball stud 32 includes a first or top end 32a, a second or bottom end 32b that is opposite to the first end 32a, and a longitudinal axis defined therebetween. Ball stud 32 also defines an external surface 32c that extends between the first end 32a and the second end 32b and is configured to engage with the housing 20 or a race member of sensor unit 10, which is discussed in greater detail below. Ball stud 32 also defines a cavity 32d that extends downwardly into the ball stud 32 from the first end 32a to an internal base wall 32e of ball stud 32 along the longitudinal axis of the ball stud 32; such uses and purposes of cavity 32d and internal base wall 32e are discussed in greater detail below. Ball stud 32 also defines an internal threading 32f that extends downwardly into the ball stud 32 from the internal base wall 32e towards the second end 32b; such use and purpose of internal threading 32f is also discussed in greater detail below.

Ball stud 32 also defines a groove 32g. As best seen in FIGS. 5 and 6, groove 32g extends downwardly from the first end 32a to the second end 32b. In operation, groove 32g may be configured to receive lubricant to help lubricate the ball stud 32 with housing 20 and/or other components of sensor unit 10.

As discussed previously, the pivot point 2c of articulating chassis 2 is the center point of ball stud 32 between the first end 32a and the second end 32b. As such, the front articulating frame 2a and the rear articulating frame 2b pivot, rotate, and/or articulate at the pivot point 2c when the front articulating frame 2a is turned or rotated by the operator or when the front articulating frame 2a and the rear articulating frame 2b independently when the articulating tractor 1 is traversing over uneven terrain.

Ball joint member 30 also includes a shank 34 that extends from the second end 32b of ball stud 32. As best seen in FIGS. 5 and 6, shank 34 includes a first or top end 34a that forms with the second end 32b of ball stud 32, a second or bottom end 34b that is opposite to the first end 34a and is spaced apart from the ball stud 32, and a longitudinal axis defined between the first end 34a and the second end 34b and is parallel with the longitudinal axis of the ball stud 32. Referring now to FIG. 5, shank 34 also defines a threading 34c that extends upwardly along the shank 34 from the second end 34b to a shoulder 34d. Shank 34 also defines a through-hole 34e between the second end 34b and the shoulder 34d and interrupts the threading 34c. In the present disclosure, the through-hole 34e extends along an axis that is orthogonal to the longitudinal axis of the shank 34.

Upon assembly, a nut 36 is threadedly engaged with the shank 34 at the threading 34c once the shank 34 of the ball joint member 30 operably engages with the rear articulating frame 2b (see FIG. 2). A cotter pin 38 may also operably engage with the shank 34 at the through-hole 34e subsequent to the nut 36 being threadedly engaged with the shank 34. Such use of the cotter pin 38 prevents the nut 36 from threadedly disengaging the shank 34 due to mechanical forces applied to and experienced by the shank 34 and the nut 36 as the articulating tractor 1 traverses over terrain.

Sensor unit 10 also includes a position indicator 40 that operably engages with the ball joint member 30. As best seen in FIG. 6, position indicator 40 operably engages with the ball stud 32 of ball joint member 30 inside of the cavity 32d. In the present disclosure, position indicator 40 is formed by a set of magnets 43a, 43b that are releasably secured to the ball stud 32 by a connector 42 that threadedly engages with the ball stud 32 at the internal threading 32f. As best seen in FIG. 6, the set of magnets includes a position magnet 43a and is retained by a pair of retaining magnets 43b inside of the ball stud 32. It should be noted that the position magnet 43a is primarily used as the magnet to assist a position sensor unit of the sensor unit 10 to determine the position of the ball joint member 30. In other exemplary embodiments, the pair of retaining magnets 43b along with the position magnet 43a may be used to assist a position sensor unit of the sensor unit 10 to determine the position of the ball joint member 30. Position indicator 40 also includes an axis that extends along the length of position indicator 40; such axis is denoted by a dashed line labeled “Y1” in FIGS. 6, 7, and 8. In operation, and as discussed in greater detail below, the displacement of the position indicator 40 is monitored and measured by a position sensor of the sensor unit 10 so that an operator controlling the articulating tractor 1 may view the oscillation or articulation of the articulating tractor 1 from the tractor itself or at a distance away from the articulating tractor 1 via remote control unit 7.

Sensor unit 10 also include a position sensor unit (hereinafter “position sensor”) 50 that operably engages with the housing 20. As best seen in FIGS. 5 and 6, position sensor 50 threadedly engages with the housing 20 at the first end 20a via the internal threading 20d. As discussed in greater detail below, position sensor 50 is configured to monitor and measure the position indicator 40 so that an operator controlling the articulating tractor 1 may view the oscillation or articulation of the articulating tractor 1 from the tractor itself or at a distance away from the articulating tractor 1 via remote control unit 7. The components and features of the position sensor 50 are now discussed in greater detail below.

Position sensor 50 includes a sensor 52 having a second axis “Y2” (denoted by a dashed line in FIGS. 6, 7C, and 8) that operably engages with a body 54. As best seen in FIG. 5, body 54 includes a first end 54a that is open, a second end 54b that is closed and is opposite to the first end 54a, and a cavity 54c defined in the body 54 that extends from the first end 54a and terminates at a base wall 54d. In the present disclosure, the sensor 52 is entirely housed inside of the cavity 54c of the body 54.

The body 54 also includes an external threading 54e that extends outwardly from the body 54 and is positioned outside of the cavity 54c. The external threading 54e matches with the internal threading 20d of the housing 20 to threadedly engage the housing 20 and the body 54 with one another. Body 54 also includes a plurality of facets 54f that is positioned between the first end 54a and the external threading 54e. In operation, a torque wrench or similar tool may engage with the body 54 at the plurality of facets 54f to threadedly engage the body 54 with the housing 20 at a desired torque so that body 54 is secured to the housing 20. Body 54 also defines a notch 54g that extends downwardly into the body 54 from the first end 54a towards the second end 54b (see FIG. 3). Notch 54g provides access to a portion of the sensor 52 inside of body 54 for enabling an operator to grab or grasp the sensor 52 with a tool when the operator desires to remove the sensor 52 from the body 54. Body 54 also defines an annular recess 54h at a location between the first end 54a and the second end 54b inside of the cavity 54c; such use and purpose of annular recess 54h is discussed in greater detail below.

Position sensor 50 also includes a gasket 56. As best seen in FIG. 5, gasket 56 is housed inside of the annular recess 54h of the body 54. Upon assembly, gasket 56 operably engages with the sensor 52 and the body 54 to frictionally engage the sensor 52 with the body 54. It should be noted that gasket 56 may also prevent fluid, dust, or other external materials surrounding the position sensor 50 from traveling down into the body 54 that may disrupt or interfere with measurements taken by the sensor 52.

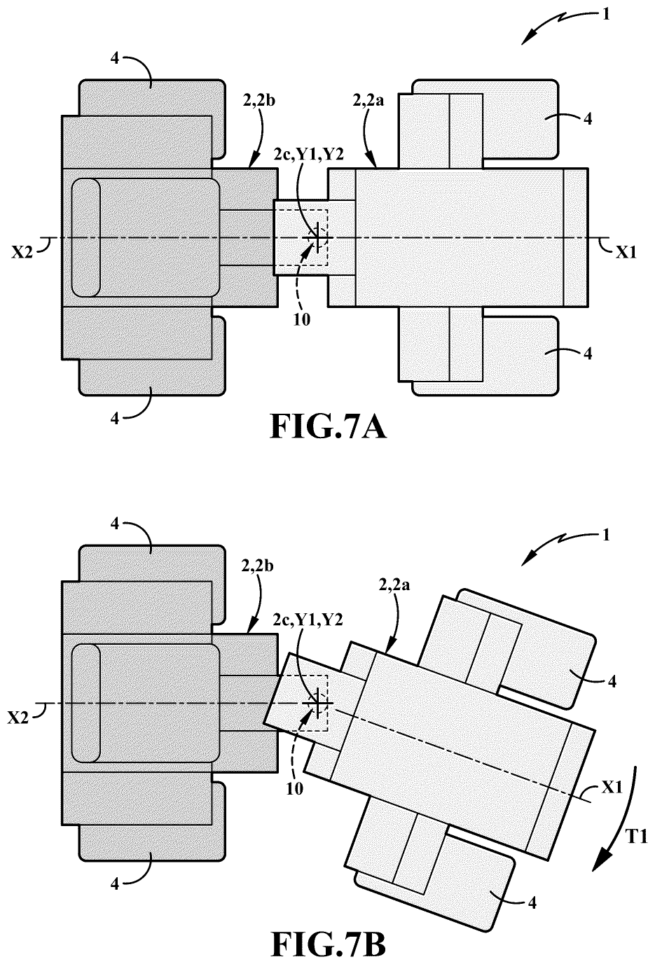

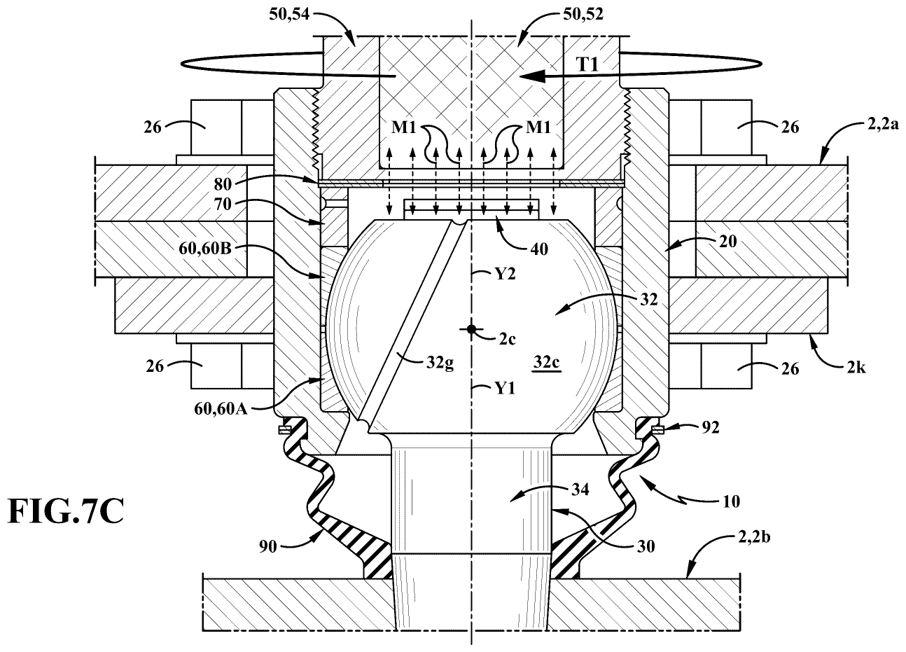

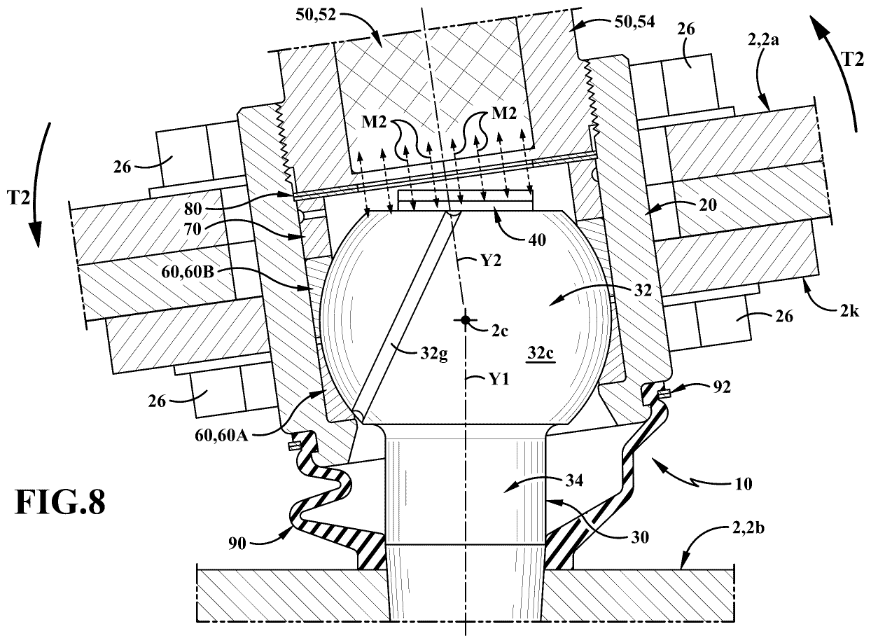

In operation, sensor 52 of position sensor 50 is configured to measure the displacement of the position indicator 40 inside of the housing 20 as the articulating tractor 1 traverses along an uneven terrain. In one instance, and as best seen in FIG. 7C, the sensor 52 may measure the displacement of the position indicator 40 as the ball joint member 30 and position indicator 40 collectively rotate about the axis “Y1” of position indicator 40; such measurement occurs when the front articulating frame 2a pivots about the vertical axis “Y” of articulating tractor 1 relative to the rear articulating frame 2b. In another instance, and as best seen in FIG. 8, the sensor 52 may also measure the displacement of the position indicator 40 as the ball joint member 30 and position indicator 40 collectively pivot on the axis “Y1” of the sensor unit 10; such measurement occurs when the front articulating frame 2a rotates or tilts about the longitudinal axis of articulating tractor 1 relative to the rear articulating frame 2b. It should be noted that all measurement data measured by the sensor 52 is transmitted to the controller 6 via an electrical connection 58 that connects the controller 6 and the sensor 52 with one another.

Sensor unit 10 also includes a race member 60 that operably engages with the housing 20 and the ball joint member 30. Particularly, and as best seen in FIG. 6, race member 60 operably engages with the housing 20 and the ball stud 32 of ball joint member 30. It should be noted that race member 60 is positioned between the first vertical internal wall 20e of housing 20 and the ball stud 32 when viewed from a sectional view (see FIGS. 5 and 6).

Referring to FIG. 6, race member 60 is formed by a first or lower portion 60A and a second or upper portion 60B. It should be understood that lower portion 60A and upper portion 60B are identical to one another and such elements of each portion 60A, 60B are identical to one another. As best seen in FIG. 6, lower portion 60A and upper portion 60B each includes an external wall 60a that operably engages with the housing 20 inside of the passageway 20c, particularly the first vertical internal wall 20e of housing 20. Each of lower portion 60A and upper portion 60B also includes an internal wall 60b that faces in an opposite direction of the external wall 60a and operably engages with the ball stud 32. It should be noted that the shape of the internal wall 60b of each portion 60A, 60B matches with and/or corresponds to the shape of the external surface 32c of ball stud 32 so that ball stud 32 may glide and/or slide along the internal wall 60b of the race member 60 with ease when the ball joint member 30 is articulated by the articulating chassis 2.

Race member 60 also defines a channel 60c that is defined between the lower portion 60A and the upper portion 60B. While not illustrated herein, a lubricant may pass through the channel 60c between the lower portion 60A and the upper portion 60B so that the lubricant is disposed between the ball stud 32 and the internal wall 60b of the race member 60. Such lubrication between the ball stud 32 and the internal wall 60b of the race member 60 may enable to ball stud 32 to glide and slide along the internal wall 60b with ease when the ball joint member 30 is articulated by the articulating chassis 2.

Sensor unit 10 also includes a spacer 70 that operably engages with the housing 20, the position sensor 50, and the race member 60. Particularly, and as best seen in FIG. 6, spacer 70 operably engages with the first vertical internal wall 20e of the housing 20, the second end 54b of body 54 of position sensor 50, and the race member 60. It should be noted that spacer 70 is positioned vertically between the position sensor 50 and the race member 60 when viewed from a sectional view (see FIGS. 5 and 6). With such placement of spacer 70, the ball joint member 30 and the position sensor 50 are positioned at a distance away from one another so that the ball joint member 30 and the position indicator 40 may collectively move freely inside of housing 20. As such, the position indicator 40 and the sensor 52 are also positioned at a distance away from one another due to the inclusion of spacer 70.

Referring to FIG. 6, spacer 70 includes an external wall 70a that operably engages with the housing 20 inside of the passageway 20c, particularly the first vertical internal wall 20e of housing 20. Spacer 70 also includes an internal wall 70b that faces in an opposite direction of the external wall 70a and faces into passageway 20c of housing 20. It should be noted that the spacer 70 is free from engaging with and/or interfering with the ball stud 32 of ball joint member 30 when the ball joint member 30 moves inside of the housing 20.

Spacer 70 also defines a notch 70c that extends into the external wall 70a. In the present disclosure, the notch 70c is also aligned with the side lubricant aperture 20p of housing 20. Spacer 70 also defines a passage 70d that extends from the notch 70c to the internal wall 70b. While not illustrated herein, a lubricant may be injected into the notch 70c and passage 70d, via the side lubricant aperture 20p of housing 20, in which the lubricant passes into the notch 70c and through the passage 70d to which the lubricant traverses downwardly to the ball member 30 to lubricate the ball stud 32.

Sensor unit 10 may also include a wave spring 80 that operably engages with the position sensor 50 and the spacer 70. Particularly, and as best seen in FIG. 6, wave spring 80 operably engages with the second end 54b of body 54 and with the spacer 70. Upon assembly, wave spring 80 applies a biasing force on the body 54 and the spacer 70 to remove any slack or axial movement between the body 54 and the spacer 70 inside of the housing 20.

Sensor unit 10 also includes a shroud 90 that operably engages with the housing 20 and the ball joint member 30. As best seen in FIGS. 5 and 6, shroud 90 includes a first end 90a that operably engages with the housing 20 at the extension 20i, and a second end 90b that is opposite to the first end 90a and operably engages with the shank 34 of the ball joint member 30. Shroud 90 also defines an interior space 90c between the first end 90a and the second end 90b. In the present disclosure, the interior space 90c covers a portion of the shank 34 and covers the second end 20b of the housing 20 from the exterior elements surrounding the sensor unit 10. Shroud 90 is also secured to the extension 20i of housing 20 by a retaining ring 92 that clamps the first end 90a of shroud 90 with the extension 20i inside of the groove 20j. Shroud 90 is also frictional fit to the shank 34 of ball joint member 30 to prevent exterior elements surrounding the sensor unit 10 from entering into the shroud 90 through the second end 90b.

The ball joint sensor 10 also includes two redundant circuits that operatively connects with the controller 6. In the present disclosure, a first redundant circuit that operatively connects the controller 6 and the ball joint sensor 10 with one another in which a signal outputted along such first redundant circuit ranges from 0.25V to 4.75V. Additionally, a second redundant circuit that operatively connects the controller 6 and the ball joint sensor 10 with one another in which a signal outputted along such second redundant circuit ranges from 4.75V to 0.25V. Such use of these redundant circuits allows the ball joint sensor 10 to output data to the controller 6 when one of the two redundant circuits fails or incurs issues commonly used in electronic circuitry. Additionally, each redundant circuit also include a microcontroller that communicates between the ball joint sensor 10 and the controller 6 of the tractor 1 for transmitting collected data and other information between the ball joint sensor 10 and the controller 6. In other exemplary embodiments, other suitable means of communication between the controller 6 and the ball joint sensor 10 are possible. In one exemplary embodiment, a controller area network (or CAN) may be used to provide logical and/or electrical communication between the controller 6 and the ball joint sensor 10. In another exemplary embodiment, a circuit utilizing 4-20 mA output may be used to provide logical and/or electrical communication between the controller 6 and the ball joint sensor 10.

As best seen in FIG. 1, the controller 6 also receives inputs from one or more devices connected to the tractor 1. In the present disclosure, a first input of the controller 6 is connected between the controller 6 and the remote control unit 7 when the tractor 1 is operated remotely. Particularly, the first input of the controller 6 is shown as a wireless connection between the controller 6 and the remote control unit 7 via the transmitting device 8 when the tractor 1 is operated remotely. It should be noted that a steering wheel of the tractor 1 may also be the first input of the controller 6 when the tractor 1 is operated from a driving seat or on-board said tractor 1. Additionally, a second input of the controller 6 is connected between the controller 6 and the sensor unit 10 via the electrical connection 58 to transmit collected data and other information between the ball joint sensor 10 and the controller 6.

In operation, signals transmitted from the remote control unit 8 or the steering wheel of the tractor 1 to the first input of the controller 6 are setpoint values while signals transmitted from the sensor unit 10 are feedback signals. As such, the controller 6 is configured to monitor one or more feedback signals outputted from the sensor unit 10 as the sensor unit 10 and the tractor 1 traverse over a given terrain. The controller 6 is also configured to compare the one or more feedback signals with one or more setpoint signals transmitted from the remote control unit 7 (when the tractor 1 is operated remotely) or transmitted from the steering wheel of the tractor 1 (when the tractor 1 is operated from on-board). As such, the controller 6 is configured to continuously adjust an output signal to maintain the feedback signal transmitted from the sensor unit 10 as close as possible to the setpoint signal transmitted from the remote control unit 7 or the steering wheel of the tractor 1. The controller 6 is also configured to generate an output signal that is transmitted to the steering actuator 9 to adjust the steering of the tractor 1 if desired; such generation of this output signal to the steering actuator 9 may be beneficial when the tractor 1 is being operated remotely (by remote control unit 7) or operated autonomously by suitable autonomous components that are equipped to the tractor 1. It should be noted that the first signal inputted into the controller 6 from the remoted control unit 7 or steering wheel of tractor 1 and the second signal inputted into the controller 6 from the sensor unit 10 are also compared for error detection to ensure the tractor 1 is free from being misguided while the tractor 1 is being operated.

As mentioned previously, tractor 1 may be autonomously operated by the controller 6 and other suitable autonomous components that may be equipped to the tractor 1 based on the data measured by the sensor unit 10 and outputted by said sensor unit 10. In one example, when tractor 1 is being operated through assisted steering or autonomous steering, trajectory may be predicted based on movements or readings from the data measured by the sensor unit 10 and outputted to the controller 6 and may be used to determine a static direction of the tractor 1. It should also be noted that the readings or data measured by the sensor unit 10 may also be used in conjunction with other sensor readings, such as global positioning system (GPS) readings, to assist in predicting the direction of travel for the tractor 1 when remotely operated or autonomously operated.

Having now discussed the components and features of the sensor unit 10, methods of measuring articulation of articulating tractor 1 with the sensor unit 10 are now discussed in greater detail below.

In one example, sensor unit 10 is configured to continuously measure the articulation or turning radius of the articulating tractor 1 at the pivot point 2c. As best seen in FIG. 7A, the front articulating frame 2a and the rear articulating frame 2b are provided at a first or straight configuration where a first longitudinal axis “X1” of front articulating frame 2a and the second longitudinal axis “X2” are aligned and parallel with one another. When a steering input is applied to the articulating tractor 1 (either on-board the tractor 1 or remotely from the tractor 1) to turn in a first direction, the sensor unit 10 measures the pivot or rotation of the first longitudinal axis “X1” of the front articulating frame 2a relative to the second longitudinal axis “X2” of the rear articulating frame 2b about the pivot point 2c; such turning in the first direction is denoted by an arrow labeled “T1”in FIG. 7B.

As best seen in FIG. 7C, the sensor 52 of the position sensor 50 is measuring the rotational displacement of the front articulating frame 2a relative to the position indicator 40 that is engaged with the ball joint member 30; such act of measuring the rotational displacement of the position indicator 40 by the sensor 52 is denoted by dashed double arrows labeled “M1” in FIG. 7C. Here, the sensor 52 is measuring the rotational displacement of the front articulating frame 2a to the position indicator 40 relative to the axes “X1”, “X2” of the front articulating frame 2a and the second articulating frame 2b at the pivot point 2c. The sensor 52 may continuously measure and transmit this data to the controller 6 that may output to a display on-board the articulating tractor 1 or to a remote control unit that is wirelessly connected to the articulating tractor 1.

In another example, sensor unit 10 is also configured to continuously measure the oscillation or twist of the articulating tractor 1 at the pivot point 2c. In this example, the sensor unit 10 measures the pivot or twisting of the front articulating frame 2a relative to the rear articulating frame 2b about the longitudinal axis of articulating tractor 1 via axes “Y1”, “Y2” of the sensor unit 10; such twisting of the front articulating frame 2a relative to the rear articulating frame 2b is denoted by an arrow labeled “T2”in FIG. 8.

As best seen in FIG. 8, the sensor 52 of the position sensor 50 is measuring the titling displacement of the front articulating frame 2a relative to the position indicator 40 that is engaged with the ball joint member 30; such act of measuring the titling displacement of the position indicator 40 by the sensor 52 is denoted by dashed double arrows labeled “M2” in FIG. 8. Here, the sensor 52 is measuring the titling displacement of the front articulating frame 2a relative to the displacement of the position indicator 40. Particularly, sensor unit 52 is measuring the displacement of the position indicator 40 based on the displacement of axis “Y1” of position indicator 40 relative to axis “Y2” of sensor 52 at the pivot point 2c in FIG. 8 The sensor 52 may continuously measure and transmit this data to the controller 6 that may output to a display on-board the articulating tractor 1 or to a remote control unit (e.g., remote control unit 7) that is wirelessly connected to the articulating tractor 1.

Similar to the example above, such use of measuring the oscillation of the articulating tractor 1 in this example may also be beneficial when the tractor 1 is traversing along a sloped terrain and/or uneven terrain. As such, the sensor unit 10 may be configured to measure and/or monitor a slope or pitch of the terrain at which the tractor 1 is traversing along to correct or adjust steering. Such capability may be beneficial when an operator is using the steering wheel of the tractor 1 from an on-board station (i.e., the operator's seat) and is traversing along a sloped terrain. Such capability may also be beneficial when the tractor 1 is controlled remotely or autonomously such that the steering of the tractor 1 is adjusted continuously to maintain a desired direction when traversing along sloped or uneven terrain.

In other exemplary embodiments, sensor unit 10 may be used to monitor displacement of other components or assemblies equipped to the articulating tractor 1. In one example, and as best seen in FIG. 1, a steering sensor unit 10′ may be equipped to a steering actuator 9 that pivots and turns the front articulating frame 2a relative to the rear articulating frame 2b. In this embodiment, steering sensor unit 10′ may monitor the steering characteristics of the articulating tractor 1 transmit such steering data to the controller 6. The controller 6 may output such steering data to a display on-board the articulating tractor 1 or to a remote control unit that is wirelessly connected to the articulating tractor 1. In another exemplary embodiment, the steering sensor unit 10′ may also be used in a steering knuckle assembly or similar steering assembly that monitors the steering characteristics of the respective vehicle in which the steering sensor unit 10′ is equipped to.

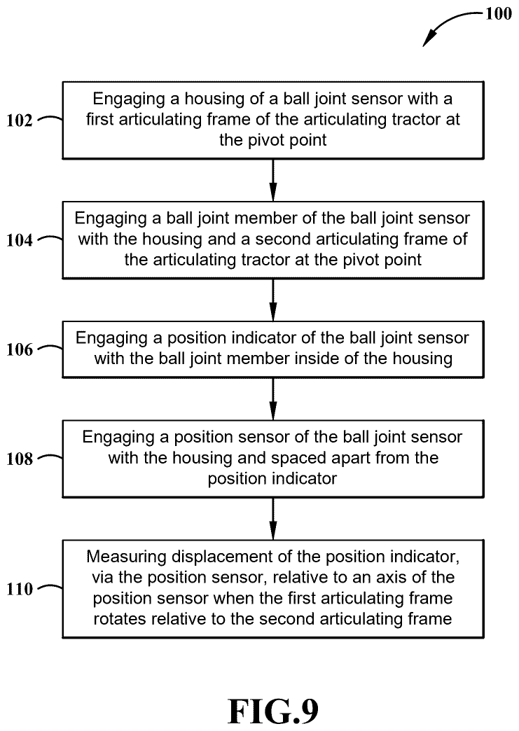

FIG. 9 illustrated a method 100 of measuring a rotational position of an articulating tractor at a pivot point. An initial step 102 of method 100 includes engaging a housing of a ball joint sensor with a first articulating frame of the articulating tractor at the pivot point. Another step 104 of method 100 includes engaging a ball joint member of the ball joint sensor with the housing and a second articulating frame of the articulating tractor at the pivot point. Another step 106 of method 100 includes engaging a position indicator of the ball joint sensor with the ball joint member inside of the housing. Another step 108 of method 100 includes engaging a position sensor of the ball joint sensor with the housing and spaced apart from the position indicator. Another step 110 of method 100 includes measuring displacement of the position indicator, via the position sensor, relative to an axis of the position sensor when the first articulating frame rotates relative to the second articulating frame.

In other exemplary embodiments, method 100 may include additional or optional steps for measuring a rotational position of an articulating tractor at a pivot point. In one exemplary embodiment, method 100 may further include a step of transmitting a turning output from the position sensor to a controller on-board the articulating tractor when the position indicator rotates about a vertical axis of the articulating tractor at the pivot point. In another exemplary embodiment, method 100 may further include a step of transmitting an articulation output from the position sensor to a controller on-board the articulating tractor when the position indicator rotates about a longitudinal axis of the articulating tractor at the pivot point. In another exemplary embodiment, method 100 may further include a step of transmitting at least one of a turning output and an articulation output to a remote control unit via a controller on-board the tractor. In another exemplary embodiment, method 100 may further include steps of engaging a shroud to the housing and to a shank of the ball joint member; and protecting the position indicator and the position sensor, by the shroud, at a position that is below the housing and the shank.

Referring back to FIG. 1, tractor 1 also includes additional components that are in logical communication with the controller 6. Particularly, tractor 1 includes an actuator controller 120 that is logically in communication with the controller 6 via a second electrical connection 122. In operation, actuator controller 120 is configured to move and control at least one steering component or actuator (such as steering actuator 9) to articulate the articulating chassis 2 about the pivot point 2c for steering operations. It should be understood that the actuator controller 120 may also be in communication with an on-board actuating system to control the actuation of steering actuator 9, which are discussed in greater detail below. In one exemplary embodiment, the actuator controller 120 may be in communication with a hydraulic system to control hydraulic fluid that is being transmitted to the steering actuator 9 during such steering operations.

Still referring to FIG. 1, tractor 1 also includes a steering sensor 128 that is operable with the steering wheel 3 and is logically in communication with the controller 6 via a fourth electrical connection 129. In operation, steering sensor 128 is configured to read and output one or more steering inputs applied to the steering wheel when the operator is operating the tractor 1 from on-board. Such steering inputs may be output to the controller 6 to provide steering assistance to the operator when operating tractor 1 to perform one or more tasks with said tractor 1, including mowing tasks with tractor 1.

Still referring to FIG. 1, tractor 1 also includes at least one computer readable medium or memory 124 that is logically in communication with the controller 6 via a third electrical connection 126. In the present disclosure, memory 124 is installed or loaded with a computer program product 130 that is accessible and executable by the controller 6. Particularly, computer program product 130 has sets of instructions 132 that are accessible and executable by the controller 6 to perform one or more steering operations when the tractor 1 is operated by an operator from on-board the tractor 1 or remotely by the remote control unit 7; such sets of instructions 132 are discussed in greater detail below. It should be noted that during execution of the computer program product 130, controller 6 may be in communication with one or more of the remote control unit 7, the sensor unit 10, and the actuator controller 120 in order to steer the tractor 1 in the direction commanded by the operator.

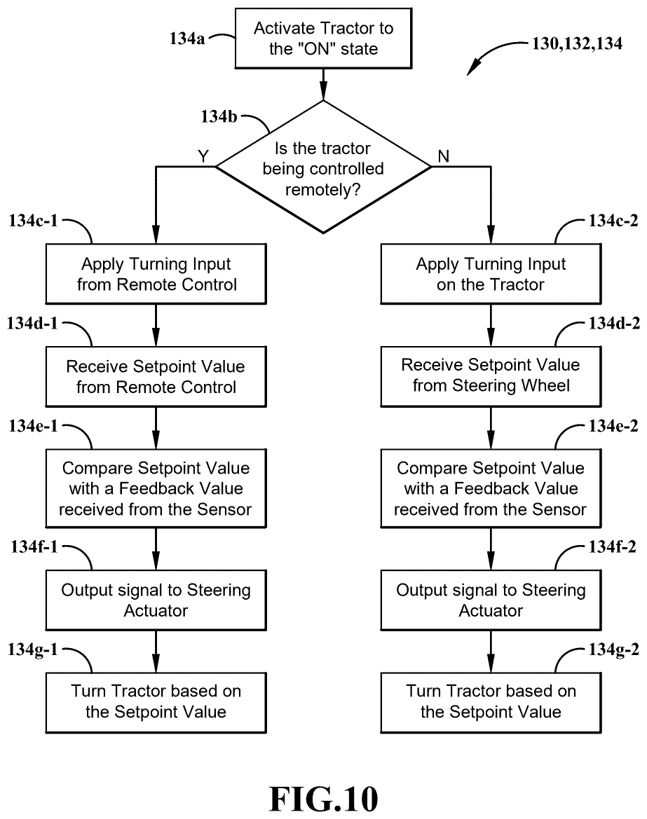

FIG. 10 illustrates a diagrammatic flowchart of a first set of instructions 134 of the computer program product 130. In general, the first set of instructions 134 is accessed and executed by the controller 6 when the tractor 1 is operated remotely by the operator from the remote control unit 7. Initially, the first set of instructions 134 includes a first or start instruction 134a that requires the tractor 1 to be activated or powered to the “ON” state; such activation by the operator may be performed from on-board or remotely.

The first set of instructions 134 further includes a second instruction 134b that is executed by controller 6 upon completion of the first instruction 134a. The second instruction 134b is executed by controller 6 to determine if the tractor 1 is being controlled remotely upon receiving the turning input performed in the second instruction 134b. If the tractor 1 is being controlled remotely from the remote control unit 7, controller 6 then proceeds to execute a third instruction 134c-1 of a group of remote-controlled steering instructions to continue monitoring of the rotational position of the articulating chassis 2 via the sensor unit 10; such decision to proceed to the third instruction 134c-1 is denoted by an arrow labeled “Y” in FIG. 10. It should be noted that such decision performed in the second instruction 134b may also be determined based on an input actuated on the remote control unit 7 by the operator or on-board the tractor 1 by the operator. In one instance, the operator may actuate an activation switch 7a of the remote control unit 7 from a deactivated remote state to an activated remote state to initiate remote control of the tractor 1. In another instance, the operator may actuate a toggle switch 142 on-board the tractor 1 from a deactivated remote state to an activated remote state to initiate remote control of the tractor 1; such toggle switch 142 is in logical communication with the controller 6 via a fifth electrical connection 143 to transmit such signal for remote control usage. It should be noted that the following instructions relate to the group of remote-controlled steering instructions of the first set of instructions 134 where each step in this group is denoted with a “-1”herein.

As mentioned briefly above, the first set of instructions 134 further includes the third instruction 134c-1 of the group of remote-controlled steering instructions that is executed by controller 6 upon completion of the second instruction 134b. The third instruction 134c-1 is executed when a turning input is applied to the tractor 1 by the operator. In this instance, when the turning input is performed remotely from the tractor 1 by the remote control unit 7, the turning input is received by the controller 6 via the antenna 8 operatively in communication with the controller 6.

The first set of instructions 134 further includes the fourth instruction 134d-1 of the group of remote-controlled steering instructions that is executed by controller 6 upon completion of the third instruction 134c-1. The fourth instruction 134d-1 is executed to command the controller 6 to receive a setpoint value from the remote control unit 7. At this stage, the setpoint value transmitted by the remote control unit 7 is performed by the operator moving or actuating a steering switch or steering joystick 7b of the remote control unit 7 in at least one position to control the turning direction of the tractor 1. The setpoint value is then analyzed and may be recorded by the controller 6 at this instruction 134d-1. It should be understood that such setpoint value transmitted by the controller 6 may be available and/or accessible at the third instruction 134c when the initial turning input was received by the controller 6.

The first set of instructions 134 further includes a fifth instruction 134e-1 of the group of remote-controlled steering instructions that is executed by controller 6 upon completion of the fourth instruction 134d-1. The fifth instruction 134e-1 is executed to command the controller 6 to compare the setpoint value analyzed in the fourth instruction 134d-1 with a feedback value transmitted from the sensor unit 10. At this stage, the controller 6 is instructed to communicate with the sensor unit 10 to receive at least feedback value that provides the rotational position or rotational displacement of the tractor 1 upon receiving the setpoint value from the remote control unit 7. Once the controller 6 receives the feedback value from the sensor unit 10, the controller 6 is instructed to compare the setpoint value of the remote control unit 7 with the feedback value of the sensor unit 10 so that the setpoint value and the feedback value are equal to one another to articulate the tractor 1 to the desired rotational value intended by the operator.

The first set of instructions 134 further includes a sixth instruction 134f-1 of the group of remote-controlled steering instructions that is executed by controller 6 upon completion of the fifth instruction 134e-1. The sixth instruction 134f-1 is executed to command to the controller 6 to output a command signal to the actuator controller 120 to actuate the steering actuator 9 to a desired rotational position based on the setpoint value discussed in fourth and fifth instructions 134d-1, 134e-1. At this stage, the actuator controller 120 is operatively in communication with the on-board hydraulic system to actuate the steering actuator 9 to the desired rotational position based on the setpoint value discussed in fourth and fifth instructions 134d-1, 134e-1.

The first set of instructions 134 further includes a seventh instruction 134g-1 of the group of remote-controlled steering instructions that is executed by controller 6 upon completion of the sixth instruction 134f-1. The seventh instruction 134g-1 is executed once the actuator controller 120 commands the steering actuator 9 to actuate from a first position to a second position in order to turn the tractor 1 based on the setpoint value initially transmitted by the remote control unit 7. Upon such completion of the seventh instruction 134g-1, the tractor 1 has been articulated to the desired rotational direction or position as commanded by the operator of tractor 1.

If, however the tractor 1 is being controlled on-board (i.e., operating the tractor 1 on-board and applying steering inputs on the steering wheel 3), controller 6 then proceeds to execute a third instruction 134c-2 of a group of on-board steering instructions; such decision to proceed to the third instruction 134c-2 of a group of on-board steering instructions is denoted by an arrow labeled “N” in FIG. 10. It should be noted that such decision performed in the second instruction 134b may also be determined based on an input actuated on the remote control unit 7 by the operator or on-board the tractor 1 by the operator. In one instance, the operator may actuate an activation switch 7a of the remote control unit 7 from an activated remote to a deactivated remote state to halt remote control of the tractor 1. In another instance, the operator may actuate toggle switch 142 on-board the tractor 1 from an activated remote state to an deactivated remote state to initiate on-board control of the tractor 1.

It should be appreciated that the steps of the group of on-board steering instructions of the first set of instructions 134 are substantially similar to the group of remote-controlled steering instructions of the first set of instructions 134 in that the same steps are performed except for third step 134c-2 of the group of on-board steering instructions because this step 134c-2 monitors a turning input applied to the steering wheel 3, not a turning input applied to the remote control unit 7. As such, a fourth step 134d-2, a fifth step 134e-2, a sixth step 134f-2, and a seventh step 134g-2 of the group of on-board steering instructions instruct the controller 6 to perform the same actions provided by the fourth step 134d-1, fifth step 134e-1, sixth step 134f-1, and seventh step 134g-1 of the remote-controlled steering instructions.

It should be understood that such first set of instructions 134 may be repeated one or more cycles depending on the number of turning inputs the operator applies to the remote control unit 7 when operating the tractor 1.

Having now discussed the first set of instructions 134, an exemplary use of the first set of instructions 134 to remotely control the tractor 1 is now discussed in greater detail below.

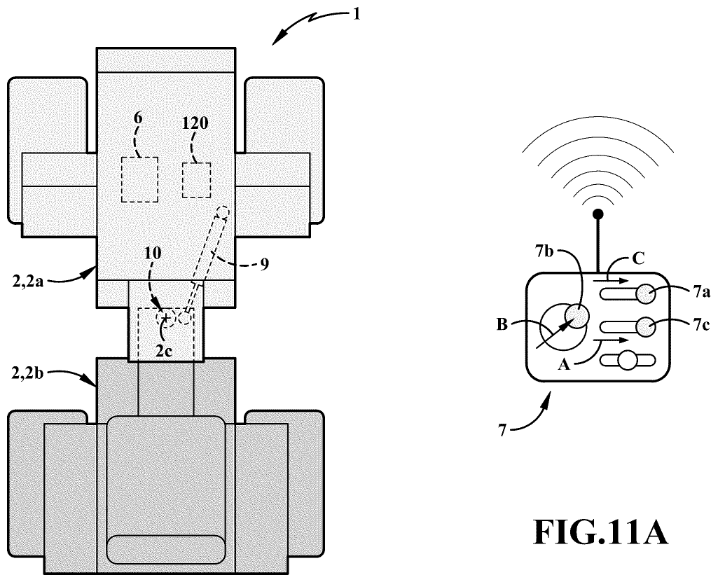

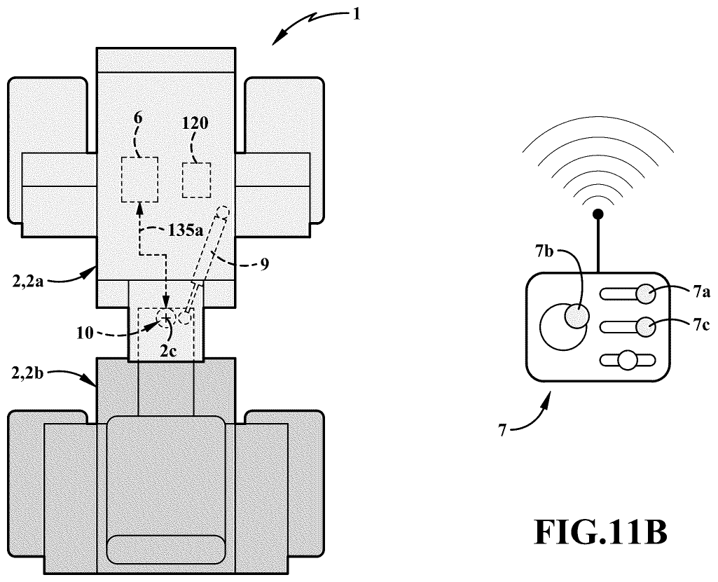

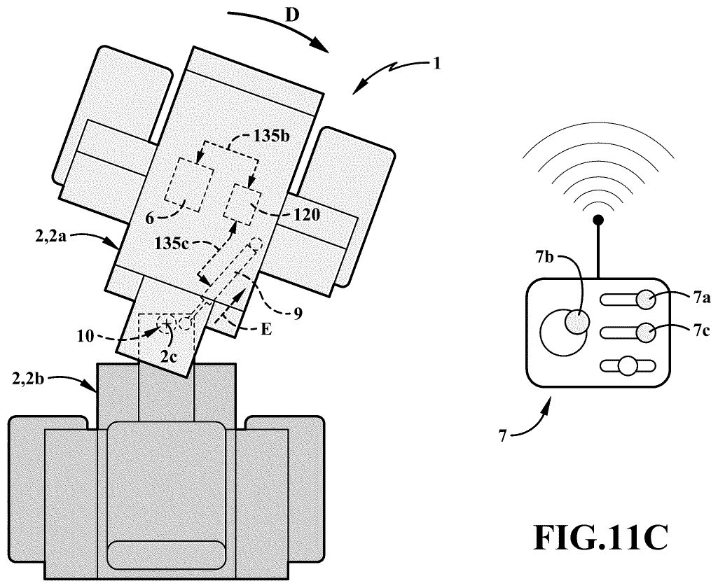

Initially, the tractor 1 is activated to an operating or “ON” state upon execution of the first instruction 134a by a switch operatively in communication with the tractor 1. In FIG. 11A, the operator may activate the tractor 1 to the operating state by activating a power switch 7c of remote control unit 7; such activation of power switch 7c is denoted by an arrow labeled “A”in FIG. 11A.

Upon such actuation, the controller 6 then executes and accomplishes the second instruction 134b to determine if the tractor 1 is being controlled remotely or being operated from on-board the tractor 1. In this exemplary embodiment, the tractor 1 is being controlled remotely from the remote control unit 7 so the controller 6 then proceeds to execute third instruction 134c-1 of the group of remote-controlled instructions to continue monitoring of rotational position of the articulating chassis 2 via the sensor unit 10. It should be noted that such decision performed in the second instruction 134d may be determined based on an input actuated on the remote control unit 7 by the operator. As such, the operator actuates activation switch 7a of the remote control unit 7 from the deactivated remote state to the activated remote state to initiate remote control of the tractor 1; such actuation of the activation switch 7a is denoted by an arrow labeled “C” in FIG. 11A. It should be noted that such activation switch 7a may be performed by the operator prior to controller 6 executing the first and/or second instructions 134a, 134b.

Upon such determination by controller 6, controller 6 continues to execute the third instruction 134c-1 when the operator applies a turning input to the tractor 1 upon operating the remote control unit 7. Particularly, when the turning input is performed remotely from the tractor 1 by the remote control unit 7, the operator applies an input on the steering joystick 7b in at least one direction; such actuation of the steering joystick 7b is denoted by an arrow labeled “B” in FIG. 11B. It should be noted that such turning input is also received by the controller 6 via the antenna 8 operatively in communication with the controller 6.

Once the turning input is received, fourth instruction 134d-1 to receive a setpoint value from the remote control unit 7. At this stage, the controller 6 analyzes and saves the setpoint value transmitted by the remote control unit 7 when the operator moves or actuates the steering joystick 7b of the remote control unit 7 in at least one position to control the turning direction of the tractor 1. As noted previously, such setpoint value transmitted by the controller may be available and/or accessible at the second instruction 134b when the initial turning input was received by the controller 6.

Once the setpoint value is received, the controller 6 then compares the setpoint value (analyzed in the fourth instruction 134d-1) with a feedback value transmitted from the sensor unit 10 in the fifth instruction 134e-1. At this stage, the controller 6 is instructed to communicate with the sensor unit 10 to receive at least feedback value that provides the rotational position or rotational displacement of the tractor 1 upon receiving the setpoint value from the remote control unit 7. In FIG. 11B, the communication between the controller 6 and the sensor unit 10 is diagrammatically shown as a dashed double arrow labeled 135a. Once the controller 6 receives the feedback value from the sensor unit 10, the controller 6 is instructed to compare the setpoint value of the remote control unit 7 with the feedback value of the sensor unit 10 so that the setpoint value and the feedback value are equal to one another to articulate the tractor 1 to the desired rotational value intended by the operator.

Once the comparison is complete, controller 6 further executes the sixth instruction 134f-1 to command the controller 6 to output a command signal to the actuator controller 120 to actuate the steering actuator 9 to a desired rotational position based on the setpoint value discussed in fourth and fifth instructions 134d-1, 134e-1. As best seen in FIG. 11C, the controller 6 outputs such command signal to the actuator controller 120 as diagrammatically shown as a dashed double arrow labeled 135b. As noted previously, the actuator controller 120 is operatively in communication with the on-board hydraulic system to actuate the steering actuator 9 to the desired rotational position based on the setpoint value discussed in fourth and fifth instructions 134d-1, 134e-1.

Lastly, the actuator controller 120 commands the steering actuator 9 to actuate from a first position to a second position in order to turn the tractor 1 based on the setpoint value initially transmitted by the remote control unit 7. As best seen in FIG. 11C, the steering command from the actuator controller 130 and the steering actuator 9 is diagrammatically shown as a dashed double arrow labeled 135c. Upon such completion of the seventh instruction 134g-1, the tractor 1 is articulated to the desired rotational direction or position as commanded by the operator of tractor 1; such articulation of tractor 1 is denoted by an arrow labeled “D” in FIG. 11C. It should be noted that such articulation of the tractor 1 may continue until the feedback value measured by the sensor unit 10 is equal to the original setpoint value transmitted from the remote control unit 7.

While not illustrated herein, similar actions are executed by the controller 6 when the group of on-board steering instructions of the first set of instructions 134 are executed when the operator is steering on-board the trailer 1.

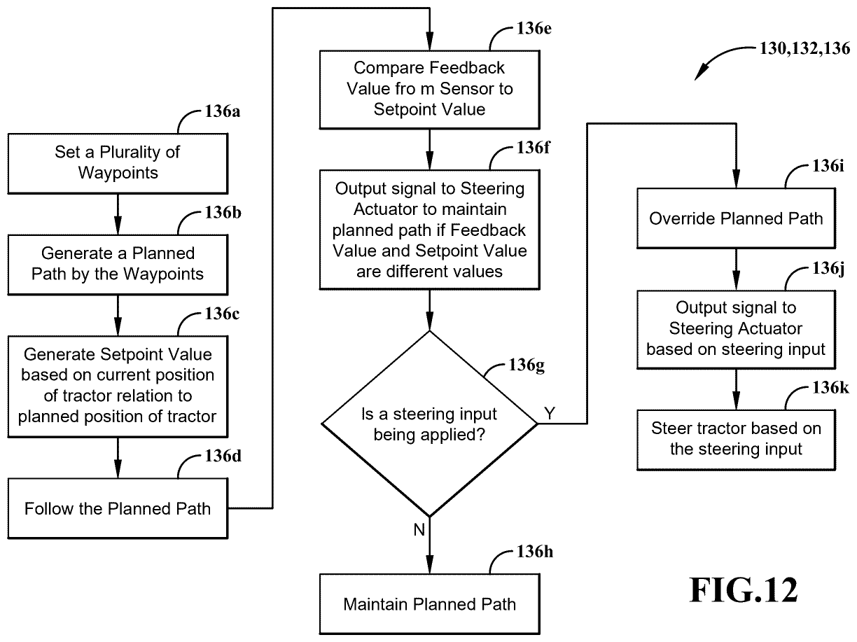

FIG. 12 illustrates another diagrammatic flowchart of a second set of instructions 136 of the computer program product 130. In general, the second set of instructions 136 is accessed and executed by the controller 6 when the tractor 1 is operated remotely by the operator from the remote control unit 7. In this set of instructions 136, however, the second set of instructions 136 are executed by controller 6 to generate a planned path or a planned cutting path defined by a plurality of waypoints that are followed by the tractor 1 until such planned path is terminated or stopped by the operator. Such instructions of the second set of instructions 136 are now discussed in greater detail below.

Initially, the second set of instructions 136 includes a first instruction 136a that requires the controller 6 to set a plurality of waypoints along a cutting or mowing line for tractor 1. In operation, the plurality of waypoints set by the controller 6 assists the operator in controlling the tractor 1 remotely by remote control unit 7 in maintaining a straight, consistent cutting line along a lawn. It should be understood that any suitable number of waypoints may be set by the controller 6 based on various considerations, including the length of cutting line. Such use of the plurality of waypoints set by the controller 6 upon accomplishing the first instruction 136a in one exemplary embodiment will be discussed in greater detail below.

The second set of instructions 136 further includes a second instruction 136b that is executed by controller 6 upon completion of the first instruction 136a. The second instruction 136b is executed by the controller 6 to generate a planned cutting path or planned mowing path (hereinafter referred to as “planned path”) between each waypoint of the plurality of waypoints set by the controller 6. As such, the planned path follows the plurality of waypoints to provide a clear, linear path for the tractor 1 to follow to cut at least one mow line on the lawn.

The second set of instructions 136 further includes a third instruction 136c that is executed by controller 6 upon completion of the second instruction 136b. Upon execution of the third instruction 136c by controller 6, the controller 6 is instructed to generate a setpoint value for the rotational position of the tractor 1 based on the current position of the tractor to intended planned position of the tractor 1. Stated differently, controller 6 is instructed to generate a setpoint value for the tractor 1 at which the tractor 1 is to maintain to follow the planned path generated in the second instruction 136b to cut a first mow line.

The second set of instructions 136 further includes a fourth instruction 136d that is executed by controller 6 upon completion of the third instruction 136c. Upon execution of the fourth instruction 136d by controller 6, the controller 6 is instructed to maintain the tractor 1 on the planned path. In one instance, such execution of fourth instruction 136d may be performed so that the tractor 1 may cut a first mow line. It should be understood that the setpoint value may continuously be output by the controller 6 to the actuator controller 120 to maintain the steering actuator 9 at this set value so the tractor 1 is prevented from deviating from the planned path.

The second set of instructions 136 further includes a fifth instruction 136e that is executed by controller 6 upon completion of the fourth instruction 136d. Upon execution of the fifth instruction 136e by controller 6, the controller 6 is instructed to compare a feedback value, which is measured by the sensor unit 10 when the tractor 1 is following the planned path, to the setpoint value executed in the third instruction 136c. As such, the controller 6 is instructed to communicate with the sensor unit 10 during the execution of the fifth instruction 136e in order to obtain a measurement of the rotational position of the tractor 1 in real-time at the pivot point 2c. Such comparison between the setpoint value and feedback value enables the controller 6 to determine if the tractor 1 has deviated from the planned path during the first mow line due to external causes. In one example, such deviation of the tractor 1 may be caused by the tractor 1 experiencing uneven terrain along the planned path that skewed or change the path of travel for the tractor 1. Once the comparison is complete, the controller 6 may refrain from outputting an adjustment steering signal to the actuator controller 120 when the setpoint and feedback values are substantially the same or equal to one another or output an adjustment steering signal to the actuator controller 120 when the setpoint and feedback values are not substantially the same or unequal to one another; such outputting of this signal is discussed in greater detail below.

The second set of instructions 136 further includes a sixth instruction 136f that is executed by controller 6 upon completion of the fifth instruction 136e. Upon execution of the sixth instruction 136f by controller 6, the controller 6 is instructed to output an adjustment steering signal to the steering actuator 9, via the actuator controller 120, to maintain the planned path if the feedback value and the setpoint value are different values. Such signal transmitted from the controller 6 to the actuator controller 120 is a value that adjusts the steering actuator 9 so that the feedback value measured by the sensor unit 10 will substantially match with or be equal to the setpoint value originally set by the controller 6. It should be noted that the sixth instruction 136f may be omitted or excluded from being executed by the controller 6 if the setpoint and feedback values are substantially the same or equal to one another.

The second set of instructions 136 further includes a seventh instruction 136g that is executed by controller 6 upon completion of the sixth instruction 136f if the setpoint and feedback values were different from one another or upon completion of the fifth instruction 136e if the setpoint and feedback values were substantially the same or equal to one another. Upon execution of the seventh instruction 136g by controller 6, the controller 6 is instructed to determine if the remote control unit 7 being operated by the operator applied a steering input via the steering joystick 7b. If the operator refrains from applying a steering input on the steering joystick 7b, the controller 6 executes the eighth instruction 136h by maintaining the planned path and continuously adjusts the tractor 1 if the tractor 1 deviates from the planned path due to external interferences. If the operator does apply a steering input on the steering joystick 7b, the controller 6 then executes the ninth instruction 136i which overrides the planned path. Such executing of the ninth instruction 136i halts the tractor 1 from following the planned path and passes control to the remote control unit 7.

It should be noted that such execution of the seventh instructions 136g may also be executed when the operator is on-board the tractor 1 and applies a steering input on the steering wheel 3. In this example, the steering sensor 128 may output a signal to controller 6 when a steering input is applied to the steering wheel 3 by operator where operator overrides the steering assistance and operates the tractor 1 manually. In this example, the toggle switch 142 is set to the deactivated remote state since the operator is operating the tractor 1 from on-board.

The second set of instructions 136 further includes a tenth instruction 136j that is executed by controller 6 upon completion of the ninth instruction 136i. Upon execution of the tenth instruction 136j by controller 6, the controller 6 is instructed to output a signal to the steering actuator 9, via the actuator controller 120, to articulate the tractor 1 accordingly based on the steering input. It should be noted that similar techniques or methods discussed herein may be used to articulate the tractor 1 accordingly based on the steering input, including the fifth instruction 136e to ensure the feedback value measured by the sensor unit is substantially similar to or matches with the setpoint value or steering input transmitted by the remote control unit 7.

The second set of instructions 136 further includes an eleventh instruction 136k that is executed by controller 6 upon completion of the tenth instruction 136j. Upon execution of the eleventh instruction 136k by controller 6, the actuator controller 120 commands the steering actuator 9 to actuate from a first position to a second position in order to turn the tractor 1 based on the steering input transmitted by the remote control unit 7. Upon such completion of the eleventh instruction 136k, the tractor 1 has been articulated to the desired rotational direction or position as commanded by the operator of tractor 1.

It should be understood that while the planned path may be terminated, the operator of the tractor 1 is able to restart and/or reactivate the instructions to set the plurality of waypoints and to generate the planned path discussed in early instructions of the second set of instructions 136.

It should also be understood that while tractor 1 is configured to follow the planned path generated upon execution of the second set of instructions 136, the operator may also vary the speed of the tractor 1 during operation. Particularly, operator may actuate a variable speed or trim speed switch 7d on the remote control unit 7 depending on various conditions, including the terrain the tractor is traversing, the slope at which the tractor is traversing, the length of grass or vegetation being cut by the tractor 1, and other considerations of the like to vary the speed of the tractor 1.

It should also be understood that operator may transition between both an on-board mode and a remote-controlled mode between one or more waypoints when the second set of instructions 136 is executed by controller 6. In one example, an operator may initially steer and/or operate the tractor 1 from on-board the tractor 1 as the tractor 1 reaches a first group of waypoints along a planned path. In this same example, an operator may then transition to steering and/or operating the tractor 1 remotely from the tractor for a preceding second group of waypoints based on various reasons, including steep or uneven terrain that the tractor may need to traverse for mowing operations.

Having now discussed the second set of instructions 136, an exemplary use of the second set of instructions 136 to control the tractor 1 is now discussed in greater detail below.

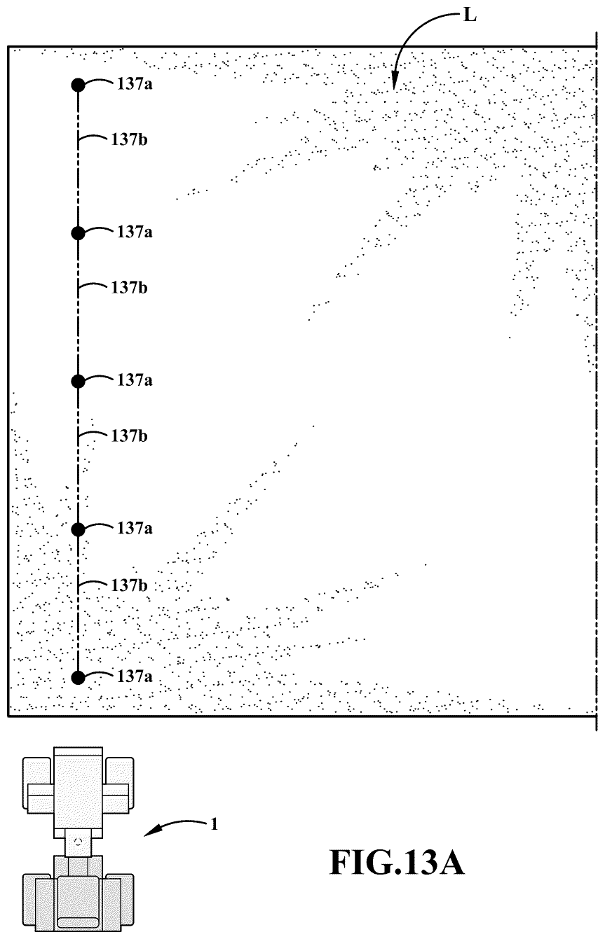

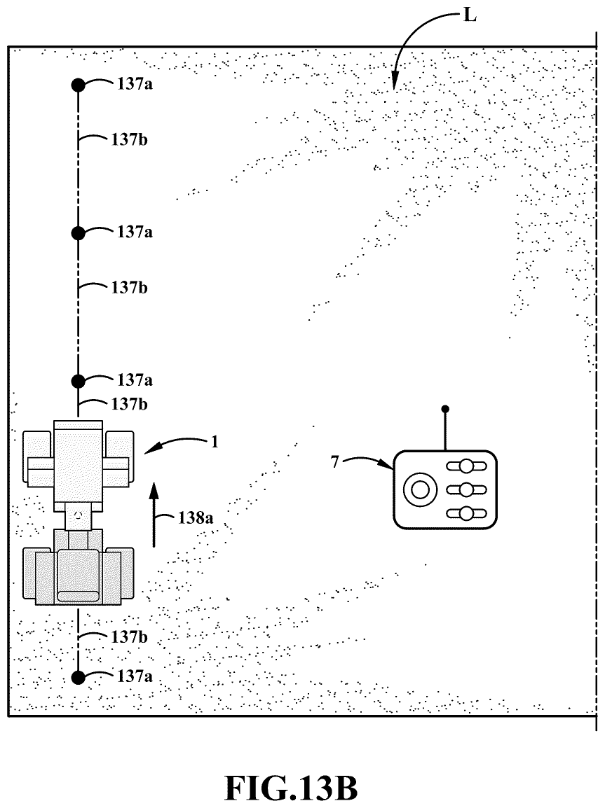

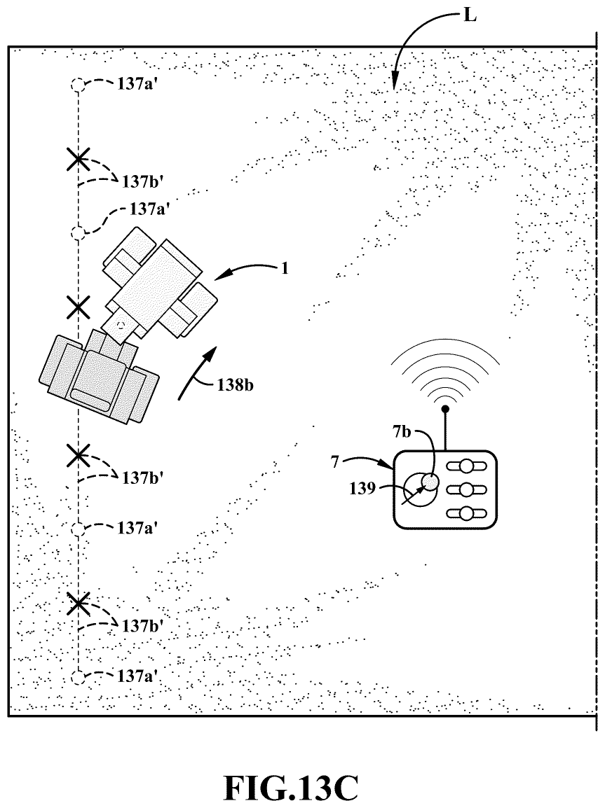

In FIG. 13A, the controller 6 executes the first instruction 136a that requires the controller 6 to set a plurality of waypoints 137a along a cutting or mowing line for tractor 1. In operation, the plurality of waypoints 137a set by the controller 6 assists the tractor 1 in maintaining a straight, consistent cutting line along a lawn 137c. It should be understood that while four waypoints 137a are set in this exemplary embodiment, any suitable number of waypoints 137a may be set by the controller 6 based on various considerations, including the length of the cutting line. Once the plurality of waypoints 137a are set, controller 6 executes the second instruction 136b to generate a planned path 137b between each waypoint of the plurality of waypoints 137a set by the controller 6. As such, the planned path 137b follows the plurality of waypoints 137a to provide a clear, linear path for the tractor 1 to follow to cut at least one mow line on the lawn.

Upon execution of the second instruction 136b by controller 6, the controller 6 is then instructed to generate a setpoint value for the rotational position of the tractor 1 based on the current position of the tractor 1 in relation to an intended or planned position of tractor 1. Stated differently, controller 6 is instructed to generate a setpoint value for the tractor 1 at which the tractor 1 is to maintain to follow the planned path generated in the second instruction 136b to cut a first mow line. Such setpoint value is based on the rotational position of the articulating chassis 2 of the tractor 1 at the pivot point 2c. One the setpoint is generated, the controller 6 is instructed to maintain the tractor 1 on the planned path so that the tractor 1 may cut the first mow line upon executing the fourth instruction 136d. It should be understood that the setpoint value may continuously be outputted by the controller 6 to the actuator controller 120 to maintain the steering actuator 9 at this set value so that the tractor 1 is prevented from deviating from the planned path.

As the tractor is following the planned path 137b and is shown in a first or non-turning orientation 138a, as shown in FIG. 13B, the controller 6 is instructed to compare a feedback value, which is measured by the sensor unit 10 when the tractor 1 is following the planned path, to the setpoint value executed in the third instruction 136c upon executing the fifth instruction 136e. As such, the controller 6 communicates with the sensor unit 10 during the execution of the fifth instruction 136e in order to obtain a measurement of the rotational position of the tractor 1 in real-time at the pivot point 2c. In this exemplary embodiment, such comparison may occur at each waypoint of the plurality of waypoints 137a or may occur continuously between each waypoint of the plurality of waypoints 137a.

Such comparison between the setpoint value and feedback value enables the controller 6 to determine if the tractor 1 has deviated from the planned path during the first mow line due to external causes. In this exemplary use, a rut or pothole may be located between two waypoints of the plurality of waypoints that may deviate the tractor 1 away from the planned path 137b and/or upstream waypoints 137a. Once the comparison is complete, the controller 6 may refrain from outputting an adjustment steering signal to the actuator controller 120 when the setpoint and feedback values are substantially the same or equal to one another or output an adjustment steering signal to the actuator controller 120 when the setpoint and feedback values are not substantially the same or equal to one another; such outputting of this signal is discussed in greater detail below.

As noted previously, the tractor 1 follows the planned path until deviation occurs and the controller 6 is instructed to output an adjustment steering signal to the steering actuator 9, via the actuator controller 120, to maintain the planned path if the feedback value and the setpoint value are different values. Such signal transmitted from the controller 6 to the actuator controller 120 is a value that adjusts the steering actuator 9 so that the feedback value measured by the sensor unit 10 will substantially match with or be equal to the setpoint value originally set by the controller 6. It should be noted that the sixth instruction 136f may be omitted or excluded from being executed by the controller 6 if the setpoint and feedback values are substantially the same or equal to one another.

As the tractor continues on the planned path 137b to cut the lawn 137c for a first mow line, the controller 6 is instructed to determine if the remote control unit 7 being operated by the operator applies a steering input via the steering joystick 7b. If the operator refrains from applying a steering input on the steering joystick 7b, the controller 6 executes the eighth instruction 136h by maintaining the planned path and continuously adjusts the tractor 1 if the tractor 1 deviates from the planned path due to external interferences. In this exemplary embodiment, and as best seen in FIG. 13C, the operator applies a steering input on the steering joystick 7b which requires the controller 6 to then execute the ninth instruction 136i which overrides the planned path and the tractor is provided in a second or turning orientation 138b; such steering input applied to the steering joystick 7b is denoted by an arrow labeled 139 in FIG. 13C. The executing of the ninth instruction 136i halts the tractor 1 from following the planned path and passes control to the remote control unit 7; such halting or termination of the waypoints are denoted by dashed boxes labeled 137a′ in FIG. 13C, and such halting or termination of the planned path is denoted by dashed lines and crosses labeled 137b′ in FIG. 13C.

It should be understood that such steering input discussed in seventh instruction 136g and ninth instruction 136i may also be applied on-board the tractor 1 by the operator when actuating or turning the steering wheel 3 in at least one direction. In this example, the toggle switch 142 is toggled to the deactivated remote state so that such commands and/or inputs applied by the operator are solely performed on-board the tractor 1.

Upon ceasing the use of the waypoints 137a and the planned path 137b, the controller 6 is instructed to output a signal to the steering actuator 9, via the actuator controller 120, to articulate the tractor 1 accordingly based on the steering input. It should be noted that similar techniques or methods discussed herein may be used to articulate the tractor 1 accordingly based on the steering input, including the fifth instruction 136e to ensure the feedback value measured by the sensor unit 10 is substantially similar to or matches with the setpoint value or steering input transmitted by the remote control unit 7. The actuator controller 120 then commands the steering actuator 9 to actuate from a first position to a second position in order to turn the tractor 1 based on the steering input transmitted by the remote control unit 7. Upon such completion of the eleventh instruction 136k, the tractor 1 has been articulated to the desired rotational direction or position (labeled 138b) as commanded by the operator of tractor 1.

Tractor 1 may also include a holster or mount 140. As best seen in FIG. 1, the holster 140 is mounted at the rear end 1b of tractor 1 behind or near an operator's seat of the tractor 1. Holster 140 is configured to support the remote control unit 7 when the remote control unit 7 is free from being used by an operator of tractor 1. It should be noted that holster 140 may be positioned along any suitable end or side of tractor 1 to support the remote control unit 7 when not being used.

It should be understood that the terms “planned path”, “planned cutting path”, and other derivatives terms of the like mentioned herein may include any suitable planned path for performing one or more different applications or services with tractor 1, including lawn or turf maintenance, snow or ice management, landscaping and groundskeeping activities, and other related applications or services that may benefit from planned path capabilities described herein.

The sensor unit or system of the present disclosure may include wireless communication logic coupled to sensors on the sensor unit or system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the sensor unit or system of the present disclosure may differ from embodiment to embodiment. In one embodiment, alerts and signals from the sensor unit or system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department. Thus, if a particular sensor unit or system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one computer readable medium or non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that are executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium, computer readable medium, or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of”shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A steering assist system operably engaged with an articulating tractor at a pivot point, the steering assist system comprising:
a controller;
a sensor unit operably engaged at the pivot point of an articulating chassis of the articulating tractor;
a steering actuator operably engaged with a front articulating frame of the articulating chassis and a rear articulating frame of the articulating chassis to pivot the articulating chassis at the pivot point based on at least one output from the controller; and
a steering unit operable with the controller to input one or more steering commands to steer the articulating tractor;
wherein the sensor unit is configured to measure rotation of the articulating chassis about a vertical axis of the articulating tractor at the pivot point.

2. The steering assist system of claim 1, further comprising:
a set of steering modes for the steering unit this stored on at least one computer readable medium encoded with instructions that is accessible by the controller.

3. The steering assist system of claim 2, wherein the set of steering modes comprises:
an on-board steering mode activated when the steering unit is being operated on-board the articulating tractor.

4. The steering assist system of claim 3, wherein the remote steering mode comprises:
a setpoint value transmitted by the steering unit to steer the articulating tractor in at least one direction; and
a feedback value measured by the sensor unit indicating a rotational position of the articulating chassis;
wherein the controller is configured to adjust the steering actuator based on a comparison between the setpoint value transmitted by the steering unit and the feedback value measured by the sensor unit.

5. The steering assist system of claim 2, wherein the set of steering modes comprises:
a remote steering mode activated when the steering unit is being operated remotely from the articulating tractor.

6. The steering assist system of claim 5, wherein the remote steering mode comprises:
a setpoint value transmitted by the steering unit to steer the articulating tractor in at least one direction; and
a feedback value measured by the sensor unit indicating a rotational position of the articulating chassis;
wherein the controller is configured to adjust the steering actuator based on a comparison between the setpoint value transmitted by the steering unit and the feedback value measured by the sensor unit.

7. The steering assist system of claim 6, wherein the remote steering mode further comprises:
an adjusted steering signal transmitted to the steering actuator from the controller, wherein the adjusted steering signal matches the feedback value with the setpoint value.

8. The steering assist system of claim 1, further comprising:
at least one computer readable medium that is accessible by the controller and encoded with instructions and a plurality of geographical waypoints to cut at least one mow line.

9. The steering assist system of claim 8, wherein the at least one computer readable medium further comprises:
a set of planned cutting path instructions to generate at least one planned cut path defined by at least two geographical waypoints of the plurality of geographical waypoints.

10. The steering assist system of claim 9, wherein the set of planned path instructions comprises:
a setpoint value transmitted by the steering unit to steer the articulating tractor in at least one direction; and
a feedback value measured by the sensor unit indicating a rotational position of the articulating chassis.

11. The steering assist system of claim 10, wherein when the steering unit is free from transmitting at least one steering command to the controller, at least one planned cut path is maintained by the controller; and
wherein when the steering unit transmits the at least one steering command to the controller, the at least one planned cut path is terminated.

12. The steering assist system of claim 8, further comprising:
an on-board steering mode activated when the steering unit is being operated on-board the articulating tractor; and
a remote steering mode activated when the steering unit is being operated remotely from the articulating tractor.

13. A method of measuring a rotational position of an articulating tractor at a pivot point, comprising steps of:
receiving a steering input having a setpoint value from a steering unit of the articulating tractor;
measuring the rotational position of an articulating chassis of the articulating tractor by a sensor unit of the articulating tractor;
transmitting a feedback value to a controller, by the sensor unit, based on the rotational position of the articulating chassis;
comparing the setpoint value and the feedback value with one another by the controller; and
adjusting the rotational position of the articulating tractor, by a steering actuator of the articulating tractor, upon receiving an output signal to match the setpoint value with the feedback value.

14. The method of claim 13, further comprising:
selecting from a set of steering modes for the steering unit this stored on at least one computer readable medium encoded with instructions that is accessible by the controller.

15. The method of claim 14, wherein the step of selecting from the set of steering modes further comprises:
selecting an on-board steering mode when the steering unit is being operated on-board the articulating tractor.

16. The method of claim 14, wherein the step of selecting from the set of steering modes further comprises:
selecting a remote steering mode when the steering unit is being operated remotely from the articulating tractor.

17. The method of claim 13, further comprising:
accessing at least one computer readable medium, by the controller, the at least one computer readable medium being encoded with instructions and a plurality of geographical waypoints to cut at least one mow line.

18. The method of claim 17, wherein the step of accessing at least one computer readable medium further comprises:
accessing a set of planned cutting path instructions stored on the at least one computer readable medium; and
generating at least one planned cut path defined by at least two geographical waypoints of the plurality of geographical waypoints.

19. The method of claim 18, wherein the step of accessing at least one computer readable medium further comprises:
maintaining the at least one planned cut path, by the controller, when the steering unit is free from transmitting at least one steering command to the controller.

20. The method of claim 18, wherein the step of accessing at least one computer readable medium further comprises:
terminating the at least one planned cut path, by the controller, when the steering unit transmits at least one steering command to the controller.
